(19) United States
(12) Patent Application Publication
(10) Pub. No.: US 2008/0317130 A1
(43) Pub. Date: Dec. 25, 2008

(54) Image converting apparatus

(75) Inventors: Yasuhiro Akiyama, Ome (JP); Hideharu Hattori, Kawasaki (JP); Koichi Hamada, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/151,678

(22) Filed: May 7, 2008

(30) Foreign Application Priority Data
May 8, 2007 (JP) 2007-122996

(51) Int. Cl. H04N 7/26

(52) U.S. Cl. 375/240.16; 382/236; 375/E07.08

(57) ABSTRACT

In an image converting apparatus, when a count value of a time period counter is equal to “1”, a motion vector rate converting unit reads out a first coefficient “KAn” from a motion vector conversion table. While the read first coefficient “KAn” is employed, the motion vector rate converting unit performs a calculating process operation (MVx=MVn×KAn) for converting rates with respect to a motion vector “MVn” of 50 Hz detected by a motion vector detecting unit in a previous step so as to acquire a motion vector “MVx” of 60 Hz. When the motion vector “MVx” is outputted from the motion vector rate converting unit, an image correcting unit performs an image correcting process operation in accordance with a predetermined algorithm by employing the motion vector “MVx” with respect to a picture signal of 60 Hz outputted from an image rate converting unit.

### INCORPORATION BY REFERENCE

The present application claims priority from Japanese application JP2007-122996 filed on May 8, 2007, the content of which is hereby incorporated by reference into this application.

### BACKGROUND OF THE INVENTION

1. Field of the Invention

The present invention is related to an image converting apparatus equipped with a frame rate converting unit, while the frame rate converting unit rate-converts an inputted picture signal having a first frame rate into another picture signal having a second frame rate, and then, outputs the rate-converted picture signal having the second frame rate.

2. Description of the Related Art

Conventionally, in converting/coding apparatuses with respect to moving picture information, one technical idea capable of performing re-coding operations at a high speed without deteriorating picture qualities, and furthermore capable of suppressing amounts of produced codes has been proposed. In the re-coding operations, a first moving picture coding system which has employed variably sub-divided blocks is re-coded into a second moving picture coding system which does not have employed the variably subdivided blocks.

In the moving picture information converting/coding apparatus related to the above-described proposed technical idea, if a correlative value “ρ” of a motion vector before a moving picture coding system is converted is larger than, or equal to a threshold value “ρ1”, then correlation is large, and an averaged value “Vm” of two motion vectors which have been calculated before the moving picture coding system has been converted is re-used as a motion vector. In such a case that the correlative value “ρ” is equal to a value defined between a threshold value “ρ2” and the threshold value “ρ1”, if the averaged value “Vm” is employed as the motion vector, then it is so judged that an error becomes large. Then, a motion vector after the conversion is re-calculated while a point of the averaged value “Vm” of the two motion vectors before the conversion is defined as a center. In such a case that the correlation value “p” is smaller than the threshold value “ρ2”, the correlation is extremely small, so that the motion vector after the conversion is re-calculated within the normal seeking range (refer to JP-A-2005-236584).

In this case, a motion vector implies the below-mentioned vector: That is, in a matching operation (in order to determine motion vector) which is executed within a predetermined seeking range between preceding images (namely, images displayed in past) and an image which is presently being displayed, this motion vector designates such a vector which connects pixels to each other which could be matched with each other in the highest degree. In other words, a motion vector has the following implication: That is, as a method for representing data of a moving picture, this motion vector corresponds to such a representing method that both a frame for constituting a reference frame (namely, image corresponding to moving picture acquired at certain instant time) and motion from the frame for constituting the reference frame are represented as a vector. As a dimension of a motion vector, a position (normally, this position is expressed as pixel number) is employed, and this motion vector indicates a moving distance.

As previously described, in the moving picture information converting/coding apparatus disclosed in JP-A-2005-236584, if the correlative value of the motion vector before the moving picture coding system is converted is larger than, or equal to the threshold value, then the averaged value of the two motion vectors calculated before the above-described motion picture coding system has been converted is re-used as the motion vector after the moving picture coding system has been converted. This vector re-use implies that a motion vector of an input picture signal is directly used as an output picture signal.

On the other hand, in the case that the above-described correlative value corresponds to a value defined between one threshold value and another threshold value, and in such a case that the above-explained correlative value is smaller than the other threshold value, the motion vectors after the motion picture coding system has been converted are re-calculated within the normal seeking range. This re-calculation of the motion vector implies that a motion vector is re-sought from an output picture signal.

However, when a motion vector of an input picture signal is directly used as a motion vector of an output picture signal, in such a case that a frame rate of the input picture is different from a frame rate of the output picture, correlative relationship between the output picture signal and the above-described motion vector is low. As a result, there is such a problem: That is, it is not possible to avoid that a large image quality deterioration occurs in the output picture signal. Also, if the method for re-seeking the motion vector thereof from the output picture signal is employed, the seeking operations of the motion vectors must be carried out with respect to both the input picture signal and the output picture signal. As a consequence, there is another problem that not only the circuit scale of the image converting apparatus is increased, but also the processing workload given to the image converting apparatus is increased.

### SUMMARY OF THE INVENTION

Accordingly, an object of the present invention is to provide an image converting technique capable of correcting images contained in an output picture signal even in such a case that a frame rate of an input picture signal is different from a frame rate of the output picture signal, while a circuit scale and a processing workload of an image converting apparatus are not increased, and furthermore, an image quality of the output picture signal is not deteriorated.

An image converting apparatus, according to a first aspect of the present invention, is featured by comprising: a frame rate converting unit for rate-converting a picture signal having a first frame rate which is inputted into a picture signal having a second frame rate to be outputted; a motion vector detecting unit for detecting a motion vector from the picture signal having the first frame rate; a motion vector rate converting unit for performing a predetermined calculating process operation with respect to the motion vector detected by the motion vector detecting unit so as to rate-convert the motion vector into such a motion vector having the same frame rate as the second frame rate of the picture signal; and a picture signal correcting unit for correcting the picture signal having the second frame rate outputted from the frame rate converting unit by utilizing the motion vector whose rate has been converted by the motion vector rate converting unit.

In a preferred embodiment related to the first aspect of the present invention, the above-described motion vector detecting unit detects such a vector which passes through pixels whose positions are equal to each other between two sets of preceding/succeeding frames which are continued to each other in the picture signal having the first frame rate as a motion vector having the first frame rate.

In another embodiment different from the above-described preferred embodiment, the above-described motion vector detecting operation by the motion vector detecting unit is carried out with respect to all of pixels which constitute each of the frames.

In another embodiment different from the above-described preferred embodiment, one of the two preceding/succeeding frames which are continued to each other in the picture signal having the first frame rate corresponds to a frame delayed by 1 frame, and the other frame thereof corresponds to a frame which is not delayed by 1 frame; and the motion vector is detected by referring to the both frames at the same time.

In another embodiment different from the above-described preferred embodiment, the above-described rate converting operation of the motion vector by the motion vector rate converting unit contains a sequence for performing a predetermined calculating process operation by employing the two preceding/succeeding motion vectors which are continued to each other and are detected from the picture signal having the first frame rate by the motion vector detecting unit.

In another embodiment different from the above-described preferred embodiment, the above-described rate converting operation of the motion vector by the motion vector rate converting unit contains a sequence for performing a predetermined calculating process operation by employing a copy of a motion vector detected from the picture signal having the first frame rate by the motion vector detecting unit, which has been produced in one preceding rate converting operation within the rate converting operation at the present time.

In another embodiment different from the above-described preferred embodiment, the above-described predetermined calculating process operation corresponds to such a calculating process operation with employment of a first coefficient, or both the first coefficient and a second coefficient, which are required so as to rate-convert the motion vector detected from the picture signal having the first frame rate by the motion vector detecting unit.

In another embodiment different from the above-described preferred embodiment, a ratio of the first coefficient to the second coefficient is variably changed in response to a time period of rate-converting operation for rate-converting the motion vector of the picture signal having the first frame rate into the motion vector of the picture signal having the second frame rate, while the time period is determined based upon the picture signal having the first frame rate and the picture signal having the second frame rate.

Furthermore, in another embodiment different from the above-described preferred embodiment, the above-described motion vector detected by the motion vector detecting unit is saved under such a condition that an information amount of the motion vector has been thinned in accordance with a predetermined sequence; and when the motion vector is rate-converted by the motion vector rate converting unit, the thinned information amount of the motion vector is restored to the original information amount thereof in accordance with the predetermined sequence.

A digital TV (television) broadcasting receiver, according to a second aspect of the present invention, is featured by comprising: a picture signal input/output unit for inputting/outputting a picture signal; an image displaying unit; a picture signal processing unit for performing a predetermined signal process operation with respect to the supplied picture signal and for outputting the signal-processed picture signal to the image display unit; and a recording/reproducing unit for recording thereon the picture signal entered via the picture signal input/output unit, and for reproducing the recorded picture signal to output the reproduced picture signal to any one of the picture signal input/output unit and the picture signal processing unit; and in which the picture signal processing unit includes: a frame rate converting unit for rate-converting a picture signal having a first frame rate which is inputted thereinto into a picture signal having a second frame rate to be outputted; a motion vector detecting unit for detecting a motion vector from the picture signal having the first frame rate; a motion vector rate converting unit for performing a predetermined calculating process operation with respect to the motion vector detected by the motion vector detecting unit so as to rate-convert the motion vector into such a motion vector having the same frame rate as the second frame rate of the picture signal; and a picture signal correcting unit for correcting the picture signal having the second frame rate outputted from the frame rate converting unit by utilizing the motion vector whose rate has been converted by the motion vector rate converting unit.

An image converting method, according to a third aspect of the present invention, is featured by comprising: a first step for rate-converting a picture signal having a first frame rate which is inputted thereinto into a picture signal having a second frame rate to be outputted; a second step for detecting a motion vector from the picture signal having the first frame rate; a third step for performing a predetermined calculating process operation with respect to the motion vector detected in the second step so as to rate-convert the motion vector into such a motion vector having the same frame rate as the second frame rate of the picture signal; and a fourth step for correcting the picture signal having the second frame rate outputted in the first step unit by utilizing the motion vector whose rate has been converted in the third step.

In accordance with the present invention, it is possible to provide the image converting technique capable of correcting the images contained in the output picture signal even in such a case that the frame rate of the input picture signal is different from the frame rate of the output picture signal, while the circuit scale and the processing workload of the image converting apparatus are not increased, and furthermore, the image quality of the output picture signal is not deteriorated.

Other objects, features and advantages of the invention will become apparent from the following description of the embodiments of the invention taken in conjunction with the accompanying drawings.

### BRIEF DESCRIPTION OF THE DRAWINGS

FIG. 1 is a functional block diagram for indicating an entire arrangement of a digital TV receiver according to an embodiment of the present invention.

FIG. 2 is a functional block diagram for showing an entire arrangement of an image converting apparatus according to an embodiment of the present invention.

FIG. 3 is a functional block diagram for representing process operations executed when a rate of a frame and a rate of a motion vector are converted in a major portion of the image converting apparatus indicated in FIG. 2.

FIG. 4 is a schematic diagram for indicating a summary as to a detecting operation of a motion vector performed in a motion vector detecting unit, and a rate converting operation (converted from 50 Hz to 60 Hz) of the motion vector performed in a motion vector rate converting unit, which are shown in FIG. 2 and FIG. 3.

FIG. 5 is an explanatory diagram for indicating one example of a motion vector converting coefficient table employed in the image converting apparatus shown in FIG. 2.

FIG. 6 is an explanatory diagram for showing relationship between a motion vector of 50 Hz which is entered to the motion vector rate converting unit, and another motion vector of 60 Hz which is outputted from the motion vector rate converting unit.

FIG. 7A and FIG. 7B are explanatory diagrams for showing rate converting sequences which are executed in the motion vector rate converting unit when the motion vector of 50 Hz is converted into the motion vector of 60 Hz.

FIG. 8A and FIG. 8B are schematic diagrams for indicating one example as to arranging relationship between the motion vector of 50 Hz and the motion vector of 60 Hz on the motion vector rate converting unit.

FIG. 9 is a schematic diagram for indicating relationship between a frame of a picture signal having a frequency of 50 Hz and a frame of a picture signal having a frequency of 60 Hz on a time axis, and relationship between a motion vector of 50 Hz and a motion vector of 60 Hz on the time axis.

FIG. 10 is an explanatory diagram for showing one example as to output timing of such a motion vector (having 60 Hz) outputted from the motion vector rate converting unit, while the motion vector is obtained by being rate-converted in the motion vector rate converting unit.

FIG. 11 is an explanatory diagram for showing another example as to output timing of such a motion vector (having 60 Hz) outputted from the motion vector rate converting unit, while the motion vector is obtained by being rate-converted in the motion vector rate converting unit.

FIG. 12 is a flow chart for describing process operations executed by respective structural units for constructing the image converting apparatus when the image converting apparatus described in FIG. 2 performs an image converting process operation.

FIG. 13 is an explanatory diagram for indicating one example as to a thinning process operation for such a motion vector of 50 Hz which should be stored in a motion vector temporary storage area set to the motion vector storage unit.

FIG. 14A to FIG. 14C are explanatory diagrams for showing operations as to a thinning process, operation for a motion vector “MV1” of 50 Hz shown in FIG. 13, and also, a restoring process for the motion vector “MV1” of 50 Hz which has been thinning-processed.

### DETAILED DESCRIPTION OF THE INVENTION

Referring now to drawings, various embodiment of the present invention will be described in more detail.

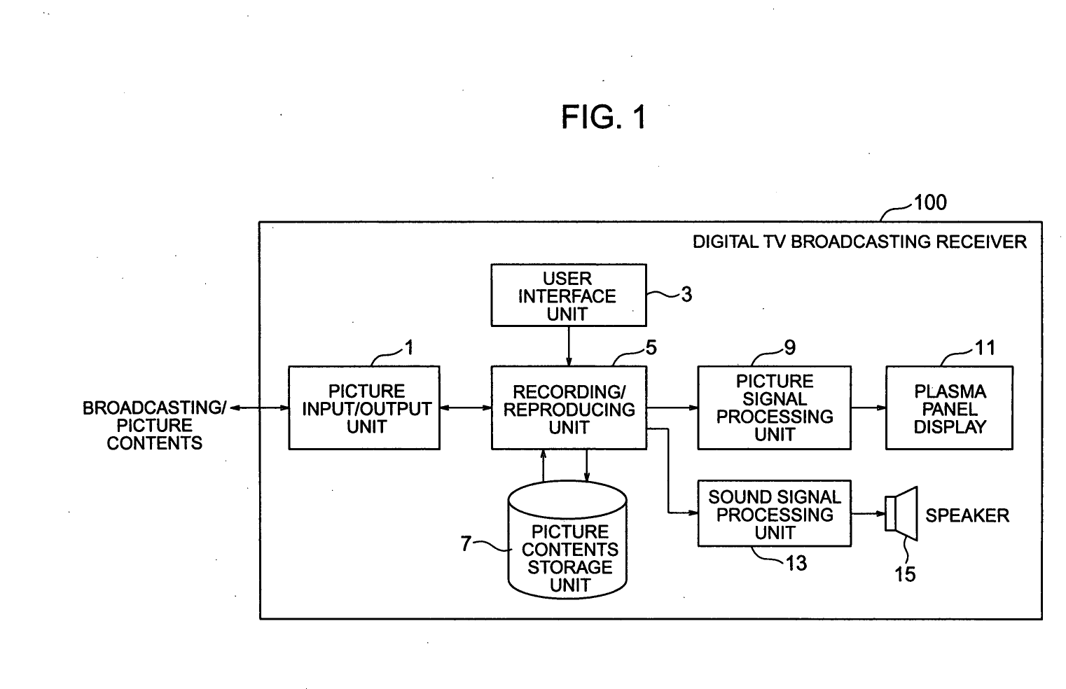

FIG. 1 is a functional block diagram for indicating an entire arrangement of a digital television (TV) broadcasting receiver 100 according to one embodiment of the present invention.

As indicated in FIG. 1, the digital TV receiver 100 according to one embodiment of the present invention is a plasma type digital TV receiver equipped with a moving picture quasi-contour correcting function. The digital TV receiver 100 is equipped with a picture input/output unit 1, a user interface (I/F) unit 3, a recording/reproducing unit 5, a picture contents storage unit 7, a picture signal processing unit 9, a plasma panel display 11, a sound signal processing unit 13, and a speaker 15.

The picture input/output unit 1 performs various process operations which are required when the digital TV receiver 100 receives digital TV broadcasting electromagnetic waves transmitted from broadcasting stations (not shown), and also, when digital picture contents present on communication network such as the Internet are downloaded to the digital TV receiver 100. Also, the picture input/output unit 1 executes process operations which are required when picture contents recorded by the digital TV receiver 100 are outputted via communication networks such as the Internet to externally provided AV appliances (not shown in drawing) and the like.

The user I/F unit 3 accepts various sorts of instructions which are transmitted from, for example, a remote controller (not shown) to the digital TV receiver 100, since a user operates the remote controller provided in the digital TV receiver 100.

In response to recording instructions of picture contents issued from the user I/F unit 3 and via the remote controller (not shown) from the user, the recording/reproducing unit 5 records thereon picture contents outputted from the picture input/output unit 1, and then outputs the recorded picture contents to the picture contents storage unit 7. Also, in response to reproducing instructions of picture contents issued from the user I/F unit 3 and via the remote controller (not shown) from the user, the recording/reproducing unit 5 reads out picture contents stored in the picture contents storage unit 7, and reproduces the read picture contents. Then, the recording/reproducing unit 5 outputs a reproduced picture signal to the picture signal processing unit 9, and outputs a reproduced sound signal to the sound signal processing unit 13, respectively.

The picture contents storage unit 7 stores thereinto the picture contents recorded in the recording/reproducing unit 5, which are outputted from the recording/reproducing unit 5, and further, outputs picture contents which have been stored thereinto to the recording/reproducing unit 5 in response to a picture contents reading request issued from the recording/reproducing unit 5.

The picture signal processing unit 9 performs a treating process operation in a predetermined sequence with respect to a picture signal outputted from the recording/reproducing unit 5, and then, outputs the processed picture signal to the plasma panel display 11 so as to be displayed thereon. The plasma panel display 11 displays thereon the picture signal outputted from the picture signal processing unit 9 as a visible image.

The sound signal processing unit 13 performs a treating process operation in a predetermined sequence with respect to a sound signal outputted from the recording/reproducing unit 5 so as to output the processed sound signal to the speaker 15. The speaker 15 outputs the sound signal outputted from the sound signal processing unit 13 as audible sound, namely sound (acoustic tone).

It should be understood that as the digital TV receiver 100, a liquid crystal display type digital TV receiver equipped with an image quality correcting function of an output image may be employed in addition to the above-described plasma type digital TV receiver equipped with the moving picture quasi-contour correcting function.

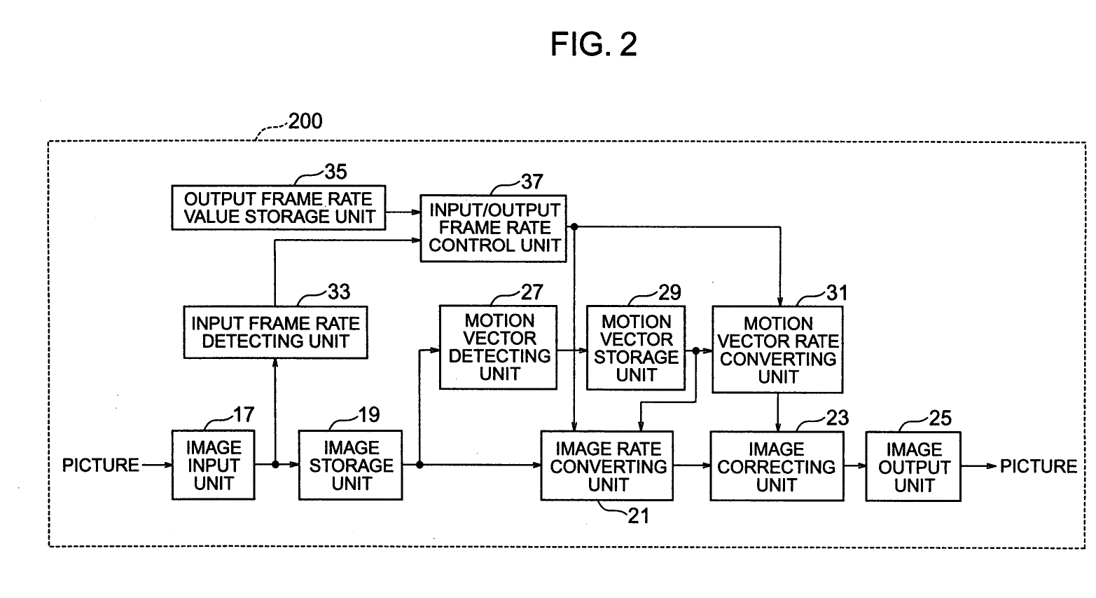

FIG. 2 is a functional block diagram for showing an entire arrangement of an image converting apparatus 200 according to an embodiment of the present invention.

The image converting apparatus 200 indicated in FIG. 2 is contained in the picture signal processing unit 9 represented in FIG. 1, and may be embodied as hardware mounted in the picture signal processing unit 9. Alternatively, the image converting apparatus 200 may be embodied as software which is installed in the hardware for constructing the picture signal processing unit 9, while the above-described hardware executes the below-mentioned image converting process operation based upon this software.

As indicated in FIG. 2, the image converting apparatus 200, according to the present embodiment of the present invention, is provided with an image inputting unit 17, an image storage unit 19, an image rate converting unit 21, an image correcting unit 23, an image outputting unit 25, a motion vector detecting unit 27, and a motion vector storage unit 29. In addition to the above-described structural units, the image converting apparatus 200 is equipped with a motion vector rate converting unit 31, an input frame rate detecting unit 33, an output frame rate value storage unit 35, and an input/output frame rate control unit 37.

The image inputting unit 17 inputs thereinto a picture signal outputted from the recording/reproducing unit 5 shown in FIG. 1, and outputs frames for all of images (also will be simply referred to as “frames” hereinafter) which constitute the inputted picture signal to the image storage unit 19 and the input frame rate detecting unit 33 respectively.

The image storage unit 29 has been constructed by employing, for example, a semiconductor memory, a magnetic disk, or the like, and stores thereinto all of the frames outputted from the image inputting unit 17. All of these frames stored in the image storage unit 19 are read out from the image storage unit 19 at predetermined timing, and then, are outputted to the image rate converting unit 21 and the motion vector detecting unit 27, respectively.

The motion vector detecting unit 27 executes a motion vector detecting operation with respect to all of pixels which constitute each of the above-described frames. That is, in the motion vector detecting operation, the motion vector detecting unit 27 refers to two sets of a preceding frame and a succeeding frame of a picture signal read out from the image storage unit 19, while the preceding frame and the succeeding frame are continued to each other in view of a temporal aspect, and then, detects such a motion vector which passes through between pixels whose positions are equal to each other. The pixel positions correspond to plane coordinates. The motion vector detecting unit 27 outputs information related to the detected motion vectors to the motion vector storage unit 29, while these motion vectors have been detected with resect to all of the pixels which constitute each of these frames. It should also be understood that output timing of a motion vector (namely, information about detected motion vector) detected by the motion vector detecting unit 27 is synchronized with timing of an input frame rate value of a picture signal outputted from the image input unit 17, while the input frame rate value of the picture signal is detected by the input frame rate detecting unit 33.

The motion vector storage unit 29 stores thereinto the information related to the above-described motion vector outputted from the motion vector detecting unit 27. The information related to the above-described motion vector stored in the motion vector storage unit 29 is read out from the motion vector storage unit 29 by the image rate converting unit 21. Similarly, the information related to the above-described motion vector is read out from the motion vector storage unit 29 by the motion vector rate converting unit 31.

The input frame rate detecting unit 33 measures output timing among the respective frames of the picture signal outputted from the image input unit 17 so as to acquire a frame rate value of the picture signal inputted to the image input unit 17. The input frame rate detecting unit 33 outputs the acquired frame rate value to the input/output frame rate control unit 37.

The output frame rate value storage unit 35 stores thereinto an output frame rate value of a picture signal from the image converting apparatus 200, while the output frame rate value has been previously set. In response to a read request issued from the input/output frame rate control unit 37, the output frame rate value storage unit 35 outputs the output frame rate value stored thereinto to the input/output frame rate control unit 37. For instance, a semiconductor storage element such as a ROM has been employed in the output frame rate value storage unit 35.

The input/output frame rate control unit 37 enters thereinto both the frame rate value of the above-described picture signal outputted from the input frame rate detecting unit 33, and the output frame rate value outputted from the output frame rate value storage unit 35. Then, the input/output frame rate control unit 37 outputs both the entered input frame rate value of the picture signal and the output frame rate value to the image rate converting unit 21 and the motion vector rate converting unit 31, respectively.

The image rate converting unit 21 enters thereinto the input frame rate value of the picture signal outputted from the input/output frame rate control unit 37, the output frame rate value of the picture converting apparatus 200, and the information related to the motion vector outputted from the motion vector storage unit 29. Then, the image rate converting unit 21 performs rate converting operations with respect to all of the frames of the picture signal outputted from the image storage unit 19 in such a manner that this frame rate converting operation can be matched with a frame rate converting condition which is determined based upon the input frame rate value, the output frame rate value, and the information related to the motion vector, which are entered thereinto. The image rate converting unit 21 outputs such a picture signal whose frame rate has been converted to the image correcting unit 23.

The motion vector rate converting unit 31 performs a rate converting operation with respect to the information related to the motion vector outputted from the motion vector storage unit 29 in order to be adapted to a frame rate converting condition which is determined based upon the input frame rate value and the output frame rate value, which are outputted from the input/output frame rate control unit 37. The motion vector rate converting unit 31 outputs information related to the motion vector whose rate has been converted to the image correcting unit 23. It should also be understood that output timing from the motion vector rate converting unit 31 as to the information related to the motion vector whose rate has been converted is synchronized with timing as to the output frame rate value which is outputted from the output frame rate value storage unit 35 via the input/output frame rate control unit 37.

The image correcting unit 23 performs an image correcting process operation with respect to the picture signal whose frame rate has been converted in accordance with a predetermined algorithm based upon the motion vector whose rate has been converted, and which is outputted from the motion vector rate converting unit 31. Now, a description is made of the image correcting process operation which is performed by the image correcting unit 23.

As one example as to the image correcting process operation performed in the image correcting unit 23, a moving picture quasi-contour correcting process operation of a plasma display (will be abbreviated as “PDP” hereinafter) is conceivable. A moving picture quasi-contour implies such a phenomenon that due to a PDP light emission structure and a nature where a sight line (LOS) of a person follows a moving direction of an image within a PDP, a human eye (visual sense) may have an optical illusion with respect to luminance gradation different from an original display pixel value in a certain picture pattern, so that the human eye may observe an image whose S/N ratio is deteriorated. Also, the above-described moving picture quasi-contour correcting process operation implies such a method capable of reducing a moving picture quasi-contour by reconstructing pixels along a move direction of the pixels, namely, along the sight line of the person with reference to a motion vector of an image.

The image correcting unit 23 outputs the picture signal to which the image correcting process operation has been performed to the image output unit 25.

The image outputting unit 25 outputs the picture signal to which the image correcting process operation has been performed and which is outputted from the image correcting unit 23 at such a timing of the output frame rate value as a picture signal from the image converting apparatus 200 to the plasma panel display 11 shown in FIG. 1.

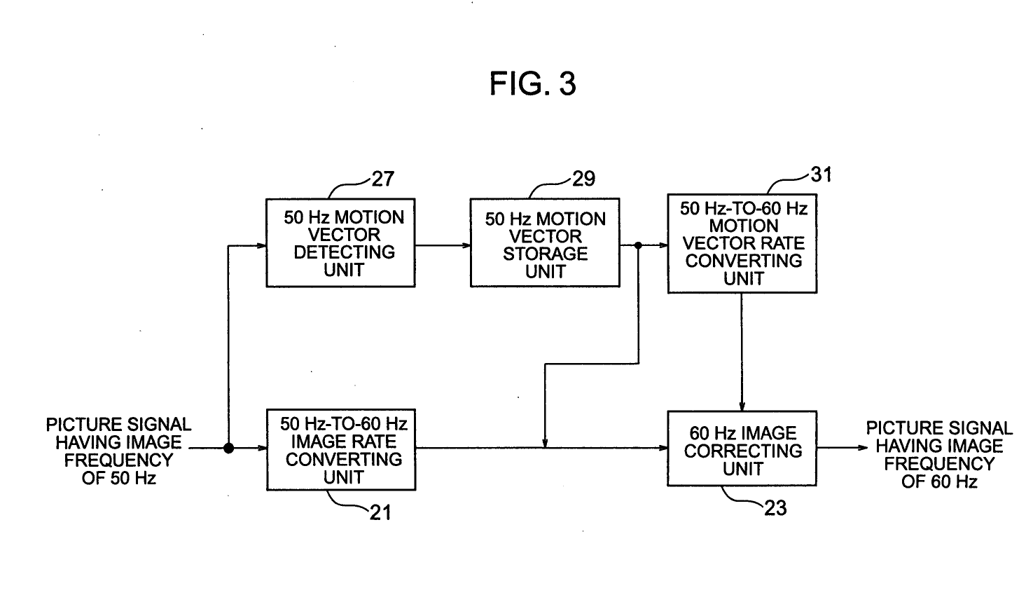

FIG. 3 is a functional block diagram for indicating process operations performed when a frame rate is converted and a motion vector rate is converted in a major unit of the image converting apparatus 200 shown in FIG. 2.

On the other hand, a frame rate of a picture signal of a TV broadcast program in Japan is 60 frames/second (will be referred to as “image frequency” and will be expressed as “60 Hz” hereinafter), whereas a frame rate of a picture signal of a TV broadcast program in Europe is 50 frames/second (will be referred to as “image frequency”, and will be expressed as “50 Hz” hereinafter). In Japan, in order to improve qualities of picture images, there are TV receiver models having the below-mentioned functions among TV receivers which are manufactured in Japan and will be exported to Europe. That is, as the above-described function, a picture signal having the image frequency of 50 Hz (will also be abbreviated as “picture signal of 50 Hz” hereinafter) is converted into such a picture signal having the image frequency of 60 Hz (will also be abbreviated as “picture signal of 60 Hz” hereinafter) on the side of these TV receivers and then the converted picture signal of 60 Hz is outputted to a display thereof.

The below-mentioned description is made based upon such an assumption that the image converting apparatus 200 converts a frame rate as to a picture signal of 50 Hz which is inputted to the image converting apparatus 200 into another frame rate as to a picture signal of 60 Hz, and then, outputs the rate-converted picture signal of 60 Hz.

In FIG. 3, the image rate converting unit 21 inputs thereinto the picture signal of 50 Hz from the image storage unit 19 shown in FIG. 2, and converts a rate of a frame of this picture signal into another frame rate of a picture signal of 60 Hz, and then, outputs the rate-converted picture signal of 60 Hz to the image correcting unit 23

The motion vector detecting unit 27 executes the below-mentioned motion vector detecting operation with respect to all of the pixels which constitute each of the respective frames. That is, the motion vector detecting unit 27 refers to two sets of a preceding frame and a succeeding frame of the picture signal of 50 Hz read out from the image storage unit 19 so as to detect such a motion vector which passes through pixels located at the same position between these two frames, while the preceding frame and the succeeding frame are continued to each other in view of the temporal aspect. The motion vector detecting unit 27 outputs the motion vectors which have been detected as to all of the pixels for constituting the respective frames to the motion vector storage unit 29 as motion vectors (will also be referred to as “motion vectors of 50 Hz” hereinafter) of the picture signal of 50 Hz.

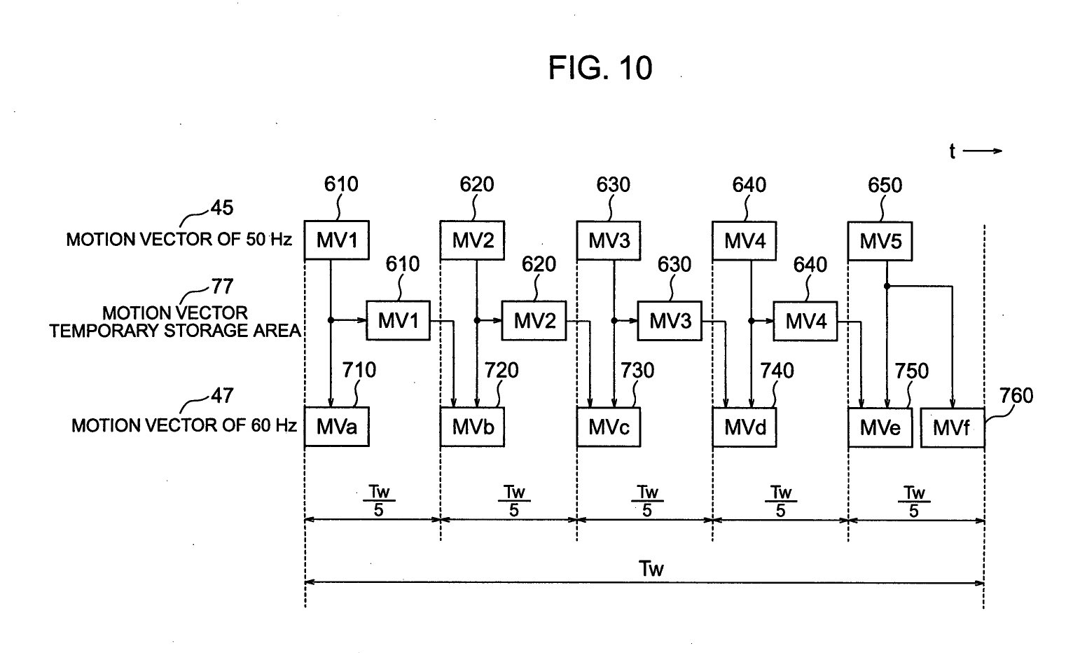

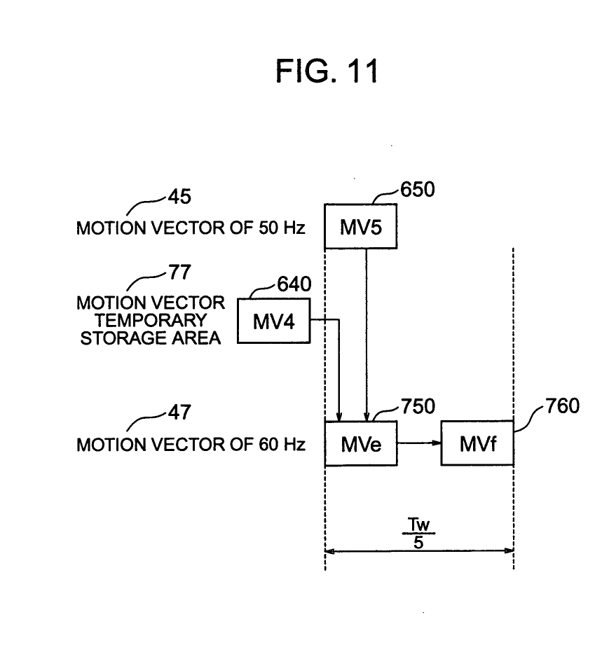

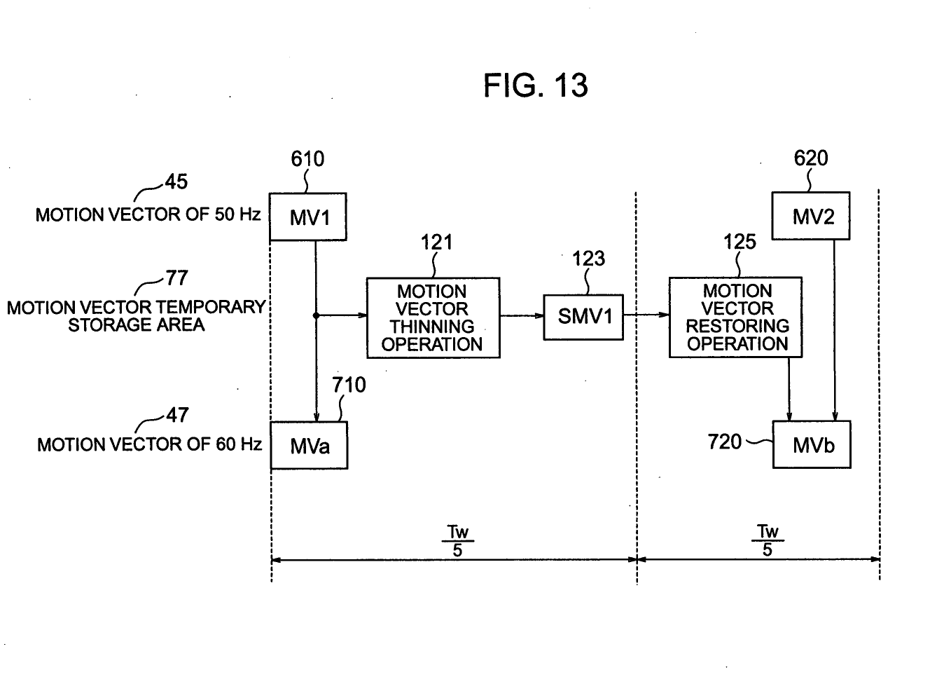

The motion vector storage unit 29 stores thereinto the motion vectors of 50 Hz outputted from the motion vector detecting unit 27. It should be understood that the below-mention motion vector temporary area (indicated by reference numeral “77” in FIG. 10, FIG. 11, and FIG. 13) has been set in the motion vector storage unit 29.

The motion vector rate converting unit 31 converts a motion vector of 50 Hz outputted from the motion vector storage unit 29 into a motion vector (will also be referred to as “motion vector of 60 Hz” hereinafter) of a picture signal of 60 Hz based upon the above-described input frame rate value (50 Hz) and output frame rate value (60 Hz) which are outputted from the input/output frame rate control unit 37 shown in FIG. 2. The motion vector rate converting unit 31 outputs the above-described motion vector (namely, motion vector of 60 Hz) acquired after the rate converting operation has been carried out to the image correcting unit 23.

The image correcting unit 23 performs an image correcting process operation in accordance with a predetermined algorithm with respect to the above-described picture signal of 60 Hz outputted from the image rate converting unit 21 based upon the motion vector of 60 Hz outputted from the motion vector rate converting unit 31. Then, the image correcting unit 23 outputs the picture signal of 60 Hz to which the image correcting process operation has been carried out to the image output unit 25 shown in FIG. 2.

It is so assumed that the image frequency of 59.94 Hz has also been contained in the above-described image frequency of 60 Hz.

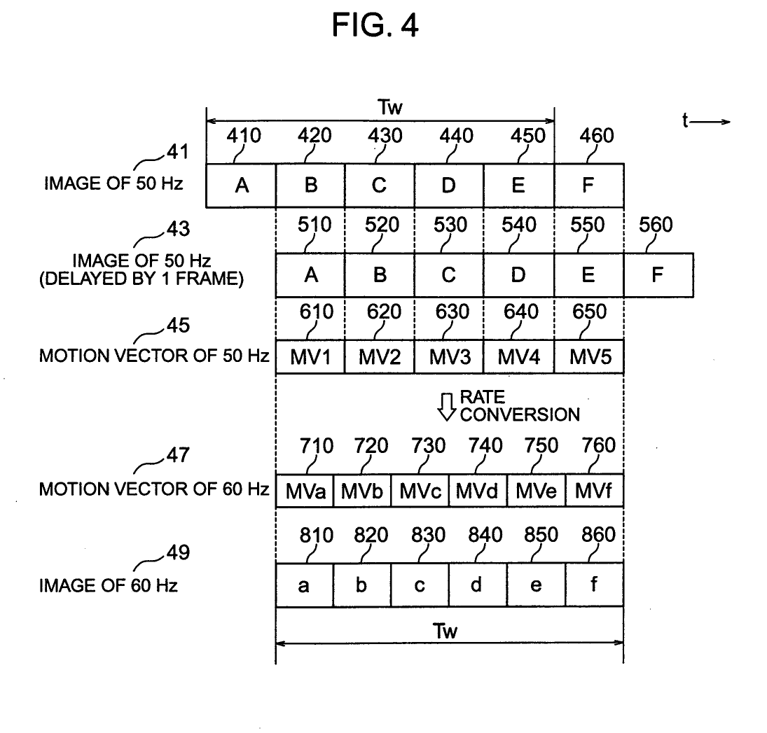

FIG. 4 is a schematic diagram for indicating a summary as to the motion vector detecting operation which is performed in the motion vector detecting unit 27 shown in FIG. 2 and FIG. 3, and the rate converting operation (from 50 Hz to 60 Hz) of the motion vector which is carried out in the motion vector rate converting unit 31.

In FIG. 4, an arrow “t” indicates a time flow.

As previously described, a motion vector of a picture signal indicates such a vector which passes through pixels whose positions (plane coordinates) are equal to each other within a predetermined area where the positions are equal to each other between two sets of preceding/succeeding frames of this picture signal, while the preceding frame and the succeeding frame are continued to each other in view of the temporal aspect.

In FIG. 4, not only one picture signal of 50 Hz of two preceding/succeeding frames which are continued to each other (in view of temporal aspect) within the picture signals of 50 Hz is outputted from the image storage unit 19 in a so-called real time in order that both the image rate converting unit 21 and the motion vector detecting unit 27 can be refer to these two preceding/succeeding frames at the same time, but also another picture signal of 50 Hz which has been delayed by 1 frame is outputted. In other words, in FIG. 4, a sign “41” is applied to one picture signal of 50 Hz, and a sign “43” is applied to such a picture signal of 50 Hz which is equal to the same picture signal of 50 Hz which has been delayed by 1 frame to be read out. The picture signal 41 of 50 Hz contains a plurality of frames ABCDEF, and similarly, the picture signal 43 of 50 Hz also contains a plurality of frames ABCDEF which are identical to the above-described plurality of frames. For the sake of easy explanations, in the frames of the picture signal 41 of 50 Hz, a sign 410 is applied to the frame A; a sign 420 is applied to the frame B; a sign 430 is applied to the frame C; a sign 440 is applied to the frame D; a sign 450 is applied to the frame E; and a sign 460 is applied to the frame F, respectively. On the other hand, in the frames of the picture signal 43 of 50 Hz, a sign 510 is applied to the frame A; a sign 520 is applied to the frame B; a sign 530 is applied to the frame C; a sign 540 is applied to the frame D; a sign 550 is applied to the frame E; and a sign 560 is applied to the frame F, respectively.

In this case, the picture signal 43 of 50 Hz which has been delayed by 1 frame implies such a picture signal of 50 Hz which was read out before the picture signal 41 of 50 Hz is read out from the image storage unit 19 by 1 preceding frame.

In order to detect the motion vectors from the picture signals 41 and 43 of 50 Hz, the motion vector detecting unit 27 temporarily holds the respective frames A to F (410 to 460) which constitute the picture signal 41 of 50 Hz read out from the image storage unit 19, and similarly, the respective frames A to F (510 to 560) which constitute the picture signal 43 of 50 Hz which has been delayed by 1 frame in view of the temporary aspect and then are read out from the image storage unit 19.

The motion vector detecting unit 27 refers to two sets of preceding/succeeding frames which are continued to each other in view of the temporal aspect between the picture signals (41 and 43) of 50 Hz read out from the image storage unit 19 so as to detect such a vector. That is, this detected vector corresponds to motion of such pixels whose plane coordinates are equal to each other within a predetermined area between these two preceding/succeeding frames. The detected vector corresponds to a motion vector of 50 Hz. The detecting operation by the motion vector detecting unit 27 with respect to the motion vector of 50 Hz is carried out within a time period indicated by a symbol “Tw” in FIG. 4, namely, within a time period designated for a rate converting process operation when the rate of the motion vector 45 of 50 Hz is converted into the rate of the motion vector 47 of 60 Hz. It should also be noted that the above-described time period “Tw” corresponds also to such a time period designated for a rate converting process operation when a frame rate of a picture signal of 50 Hz is converted into a frame rate of a picture signal of 60 Hz.

In other words, the motion vector detecting unit 27 detects a motion vector “MV1” (610) of 50 Hz in the above-described mode between the frame “B” (420) of the read picture signal 41 of 50 Hz, and the frame “A” (510) of the picture signal 43 of 50 Hz which precedes to the above-described picture signal of 50 Hz before 1 converting time period, which has been read by being delayed by 1 frame. The motion vector detecting unit 27 detects a vector “MV2” (620) of 50 Hz between the frame “C” (430) of the above-described picture signal 41 of 50 Hz and the frame “B” (520) of the above-described picture signal 43 of 50 Hz in a similar manner. Also, the motion vector detecting unit 27 detects a vector “MV3” (630) of 50 Hz between the frame “D” (440) of the above-described picture signal 41 of 50 Hz and the frame “C” (530) of the above-described picture signal 43 of 50 Hz in a similar manner.

Also, the motion vector detecting unit 27 detects a vector “MV4” (640) of 50 Hz between the frame “E” (450) of the above-described picture signal 41 of 50 Hz and the frame “D” (540) of the above-described picture signal 43 of 50 Hz in a similar manner. Furthermore, the motion vector detecting unit 27 detects a vector “MV5” (650) of 50 Hz between the frame “F” (460) of the above-described picture signal 41 of 50 Hz and the frame “E” (550) of the above-described picture signal 43 of 50 Hz in a similar manner. The above-described motion vector 45 of 50 Hz is rate-converted in the motion vector 47 of 60 Hz in the motion vector rate converting unit 31.

As previously described, the motion vector rate converting unit 31 executes such a rate converting process operation for rate-converting the motion vectors corresponding to the time period “Tw”, namely, the frame rates of the 5 motion vectors 45 of 50 Hz, which are indicated by the symbols MV1 (610), MV2 (620), MV3 (630), MV4 (640), and MV5 (650) are converted into the frame rates of the motion vectors 47 of 60 Hz. As previously described, when a frame rate of a picture signal of 50 Hz is converted into a frame rate of a picture signal of 60 Hz, the image rate converting unit 21 performs a calculation for obtaining 6 frames of an output picture signal with respect to 5 frames of an input picture signal. Similarly, when a motion vector of 50 Hz is rate-converted into a motion vector of 60 Hz, the motion vector rate converting unit 31 performs a calculation for obtaining 6 frames of motion vectors with respect to 5 frames of motion vectors detected by the motion vector detecting unit 27.

The motion vector rate converting unit 31 inputs thereinto the motion vectors 45 (MV1(610), MV2(620), MV3(630), MV4(640), and MV5(650)) of 50 Hz which are outputted from the motion vector detecting unit 27 via the motion vector storage unit 29. Then, the motion vector rate converting unit 31 converts these motion vectors of 50 Hz into motion vectors 47 (MVa (710), MVb (720), MVc (730), MVd (740), MVe (750), and MVf (760)) of 60 Hz in a predetermined converting sequence (will be discussed later), and outputs the converted motion vectors 47 of 60 Hz to the image correcting unit 23 shown in FIG. 2 and FIG. 3.

It should also be noted that in the time period “Tw”, the frames (frame A(410) to frame E(450)) of the picture signal 41 of 50 Hz are rate-converted into frames (frame “a”(810), frame “b”(820), frame “c”(830), frame “d”(840), frame “e”(850), and frame “f”(860)) of the picture signal 49 of 60 Hz in the predetermined converting sequence by the image rate converting unit 21, and then, the rate-converted frames of the picture signal 49 of 60 Hz are outputted to the image correcting unit 23.

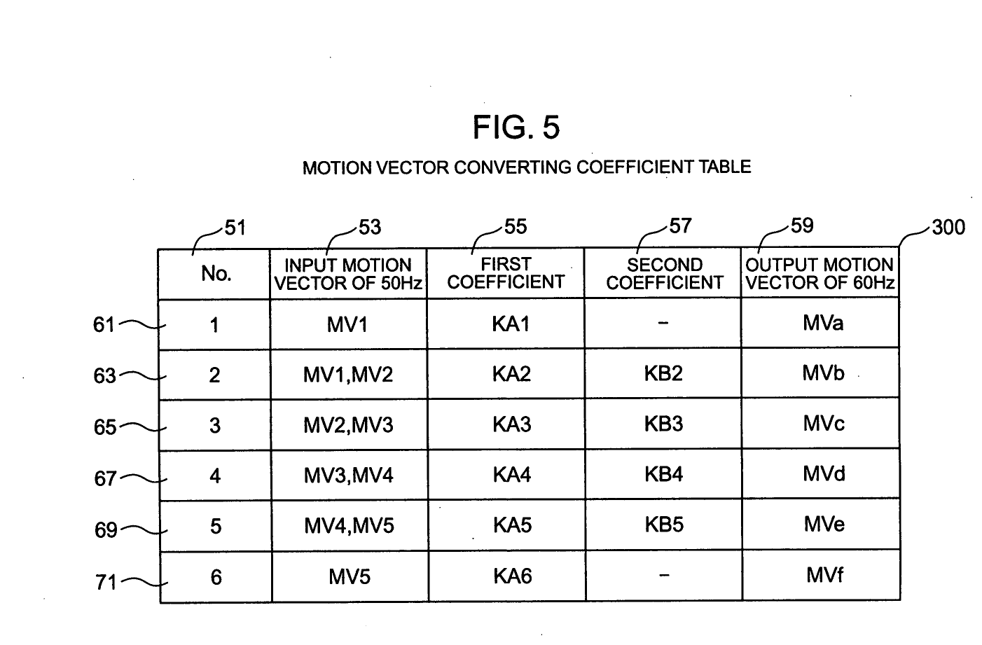

FIG. 5 is an explanatory diagram for indicating one example as to a motion vector converting coefficient table 300 which is employed in the image converting apparatus 200 described in FIG. 2.

The motion vector converting coefficient table 300 shown in FIG. 5 is stored in, for example, the motion vector rate converting unit 31. The motion vector converting coefficient table 300 is provided with a recording area 51 of numeral information for specifying the respective steps; a recording area 53 of motion vectors of 50 Hz which are inputted to the motion vector rate converting unit 31; and a recording area 55 of first coefficients which are multiplied with respect the respective motion vectors of 50 Hz which are recorded in the recording area 53. In addition to the above-described recording areas, the motion vector converting coefficient table 300 is also provided with a recording area 57 of second coefficients which are multiplied with respect to the respective motion vectors of 50 Hz which are recorded in the recording area 53; and another recording area 59 of motion vectors of 60 Hz which are outputted from the motion vector rate converting unit 31.

The respective information to be recorded in the recording area 53 correspond to the respective information to be recorded in the recording area 51; the respective information to be recorded in the recording area 55 correspond to the respective information to be recorded in the recording area 53; the respective information to be recorded in the recording area 57 correspond to the respective information to be recorded in the recording area 55; and the respective information to be recorded in the recording area 59 correspond to the respective information to be recorded in the recording area 57.

In a first step shown by a sign 61, the motion vector MV1 of 50 Hz is recorded in the recording area 53 as the input motion vector; symbol “KA1” is recorded in the recording area 55 as the first coefficient; and the motion vector MVa of 60 Hz is recorded in the recording area 59 as the output motion vector, respectively. It should also be noted that no item has been recorded in the recording area 57 to which the second coefficient should be recorded. Next, in a second step indicated by a sign 63, the motion vectors MV1 and MV2 of 50 Hz are recorded in the recording area 53 as input motion vectors; symbol “KA2” is recorded in the recording area 55 as the first coefficient; symbol “KB2” is recorded in the recording area 57 as the second coefficient; and the motion vector MVb of 60 Hz is recorded in the recording area 59 as the output motion vector, respectively.

In a third step shown by a sign 65, the motion vectors MV2 and MM3 of 50 Hz are recorded in the recording area 53 as the input motion vectors; symbol “KA3” is recorded in the recording area 55 as the first coefficient; symbol “KB3” is recorded in the according area 57 as the second coefficient; and the motion vector MVc of 60 Hz is recorded in the recording area 59 as the output motion vector, respectively. Next, in a fourth step indicated by a sign 67, the motion vectors MV3 and MV4 of 50 Hz are recorded in the recording area 53 as input motion vectors; symbol “KA4” is recorded in the recording area 55 as the first coefficient; symbol “KB4” is recorded in the recording area 57 as the second coefficient; and the motion vector MVd of 60 Hz is recorded in the recording area 59 as the output motion vector, respectively.

Next, in a fifth step shown by a sign 69, the motion vectors MV4 and MV5 of 50 Hz are recorded in the recording area 53 as the input motion vectors; symbol “KA5” is recorded in the recording area 55 as the first coefficient; symbol “KB5” is recorded in the recording area 57; and the motion vector “MVe” of 60 Hz is recorded in the recording area 59 as the output motion vector, respectively. Further, in a sixth step indicated by a sign 71, the motion vector “MV5” of 50 Hz is recorded in the recording area 53 as the input motion vector; symbol “KA6” is recorded in the recording area 55 as the first coefficient; and the motion vector “MVf” of 60 Hz is recorded in the recording area 59 as the output motion vector, respectively. It should also be noted that no item has been recorded in the recording area 57 to which the second coefficient should be recorded.

As previously described, in such a case that since the frame rate of the picture signal of 50 Hz is converted into the frame rate of the picture signal of 60 Hz, the picture signal of 50 Hz is converted into the picture signal of 60 Hz, 6 frames of the motion vectors (namely, motion vectors of 60 Hz denoted by symbols “MVa (710)” to “MVf (760)” in FIG. 4) are obtained in the motion vector rate converting unit 31 with respect to 5 frames of the motion vectors (namely, motion vectors 45 of 50 Hz indicated by symbols “MV1 (610)” to “MV5 (650)” shown in FIG. 4) which are detected by the motion vector detecting unit 27.

The rate converting sequence from the motion vector of 50 Hz to the motion vector of 60 Hz is executed by the motion vector rate converting unit 31 as follows:

That is to say, a product obtained by multiplying the first coefficient with respect to either 1 frame of a motion vector of 50 Hz or 2 continued (in view of temporal aspect) frames of motion vectors of 50 Hz detected in the motion vector detecting unit 27 by the motion vector rate converting unit 31 is assumed as a motion vector of 60 Hz. Otherwise, a summation of products obtained by multiplying the first coefficient and the second coefficient with respect to either 1 frame of a motion vector of 50 Hz or 2 continued (in view of temporal aspect) frames of motion vectors of 50 Hz detected in the motion vector detecting unit 27 by the motion vector rate converting unit 31 is assumed as a motion vector of 60 Hz. For example, in such a case that a motion vector inputted to the motion vector rate converting unit 31 corresponds to such a motion vector MV1 of 50 Hz in the first step shown in the sign 61, the output motion vector “MVa” from the motion vector rate converging unit 31 is a product made by MV1 and KA1. Also, in such a case that a motion vector inputted to the motion vector rate converting unit 31 corresponds to such motion vectors MV1 and MV2 of 50 Hz in the second step denoted by the sign 63, the motion vector “MVb” outputted from the motion vector rate converting unit 31 corresponds to such a value (MV1×KA2+MV2×KB2) which is obtained by adding the product between MV1 and KA2 to the product between MV2 and KB2.

Also, in such a case that a motion vector inputted to the motion vector rate converting unit 31 corresponds to such motion vectors MV2 and MV3 of 50 Hz in the third step denoted by the sign 65, the motion vector “MVc” outputted from the motion vector rate converting unit 31 corresponds to such a value (MV2×KA3+MV3×KB3) which is obtained by adding the product between MV2 and KA3 to the product between MV3 and KB3. Also, in such a case that a motion vector inputted to the motion vector rate converting unit 31 corresponds to such motion vectors MV3 and MV4 of 50 Hz in the fourth step denoted by the sign 67, the motion vector “MVd” outputted from the motion vector rate converting unit 31 corresponds to such a value (MV3×KA4+MV4×KB4) which is obtained by adding the product between MV3 and KA4 to the product between MV4 and KB4.

Also, in such a case that a motion vector inputted to the motion vector rate converting unit 31 corresponds to such motion vectors MV4 and MV5 of 50 Hz in the fifth step denoted by the sign 69, the motion vector “MVe” outputted from the motion vector rate converting unit 31 corresponds to such a value (MV4×KA5+MV5×KB5) which is obtained by adding the product between MV4 and KA5 to the product between MV5 and KB5. Moreover, in such a case that a motion vector inputted to the motion vector rate converting unit 31 corresponds to such a motion vector MV5 of 50 Hz in the sixth step shown in the sign 71, the output motion vector “MVf” from the motion vector rate converting unit 31 is a product made by MV5 and KA6.

A ratio of the first coefficient and the second coefficient has been previously set to a proper value based upon phase relationship between the motion vector of 50 Hz and the motion vector of 60 Hz on the time axis. It should also be noted that in the motion vector converting coefficient table 300, a total number of the above-described steps, the first coefficients, and the second coefficients may be arbitrarily changed in response to such rate converting conditions as frame rates, rates of motion vectors, and the like.

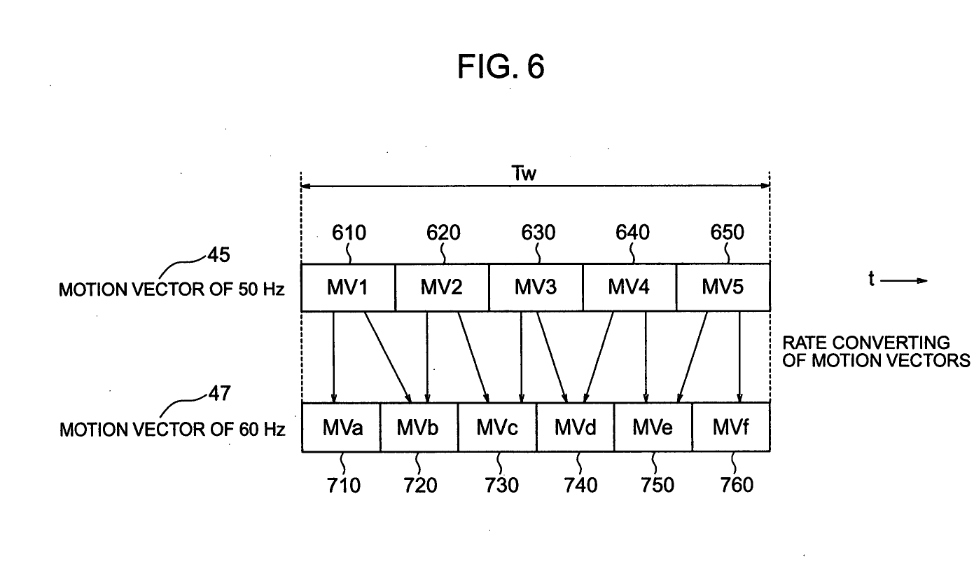

FIG. 6 is an explanatory diagram for representing relationship between the motion vector 45 of 50 Hz which is inputted to the motion vector rate converting unit 31 and the motion vector 47 of 60 Hz which is outputted from the motion vector rate converting unit 31.

Within the time period “Tw”, in such a case that 6 frames of the motion vector 47 of 60 Hz are obtained from 5 frames of the motion vector 45 of 50 Hz, the motion vector rate converting unit 31 refers to each of the 5 frames of the motion vector 45 of 50 Hz and each of the 6 frames of the motion vector 47 of 60 Hz based upon the below-mentioned correspondence relationship. The above-described time period “Tw” implies such a time period designated for the rate converting process operation when the motion vector 45 of 50 Hz is rate-converted into the motion vector 47 of 60 Hz.

In other words, in order to obtain “MVa” (710) corresponding to the motion vector 47 of 60 Hz, the motion vector rate converting unit 31 refers to MV1 (610) corresponding to the motion vector 45 of 50 Hz; and in order to obtain “MVb” (720) corresponding to the motion vector 47 of 60 Hz, the motion vector rate converting unit 31 refers to MV1 (610) and MV2 (620) corresponding to the motion vector 45 of 50 Hz, respectively. Also, in order to obtain “MVc” (730) corresponding to the motion vector 47 of 60 Hz, the motion vector rate converting unit 31 refers to MV2 (620) and MV3 (630) corresponding to the motion vector 45 of 50 Hz; and in order to obtain “MVd” (740) corresponding to the motion vector 47 of 60 Hz, the motion vector rate converting unit 31 refers to MV3 (630) and MV4 (640) corresponding to the motion vector 45 of 50 Hz, respectively.

Moreover, in order to obtain “MVe” (750) corresponding to the motion vector 47 of 60 Hz, the motion vector rate converting unit 31 refers to MV4 (640) and MV5 (650) corresponding to the motion vector 45 of 50 Hz; and in order to obtain “MVf” (760) corresponding to the motion vector 47 of 60 Hz, the motion vector rate converting unit 31 refers to MV5 (650) corresponding to the motion vector 45 of 50 Hz, respectively. The motion vector detecting unit 27 determines that any one of the motion vectors of 50 Hz is observed based upon positional relationship of the motion vectors of 60 Hz on the time axis, which should be produced by the motion vector rate converting unit 31. For instance, since the motion vector “MVa” (710) of 60 Hz has a correlative (resembling) characteristic with respect only to the motion vector MV1 (610) of 50 Hz, when the motion vector rate converting unit 31 produces the motion vector “MVa” (710) of 60 Hz, only the motion vector MV1 (610) of 50 Hz constitutes the referring subject.

However, the motion vector “MVb” (720) of 60 Hz has a correlative (resembling) characteristic with respect to the motion vectors MV1 (610) and MV2 (620) of 50 Hz; the motion vector “MVc” (730) of 60 Hz has a correlative (resembling) characteristic with respect to the motion vectors MV2 (620) and MV3 (630) of 50 Hz; the motion vector “MVd” (740) of 60 Hz has a correlative (resembling) characteristic with respect to the motion vectors MV3 (630) and MV4 (640) of 50 Hz; and the motion vector “MVe” (750) of 60 Hz has a correlative (resembling) characteristic with respect to the motion vectors MV4 (640) and MV5 (650) of 50 Hz, respectively. As a consequence, when the motion vectors “MVb” (720) to “MVe” (750) of 60 Hz are produced, the motion vector rate converting unit 31 refers to 2 sets of the motion vectors of 50 Hz respectively in the above-described mode.

It should also be understood that in FIG. 6, an arrow “t” indicates a time flow.

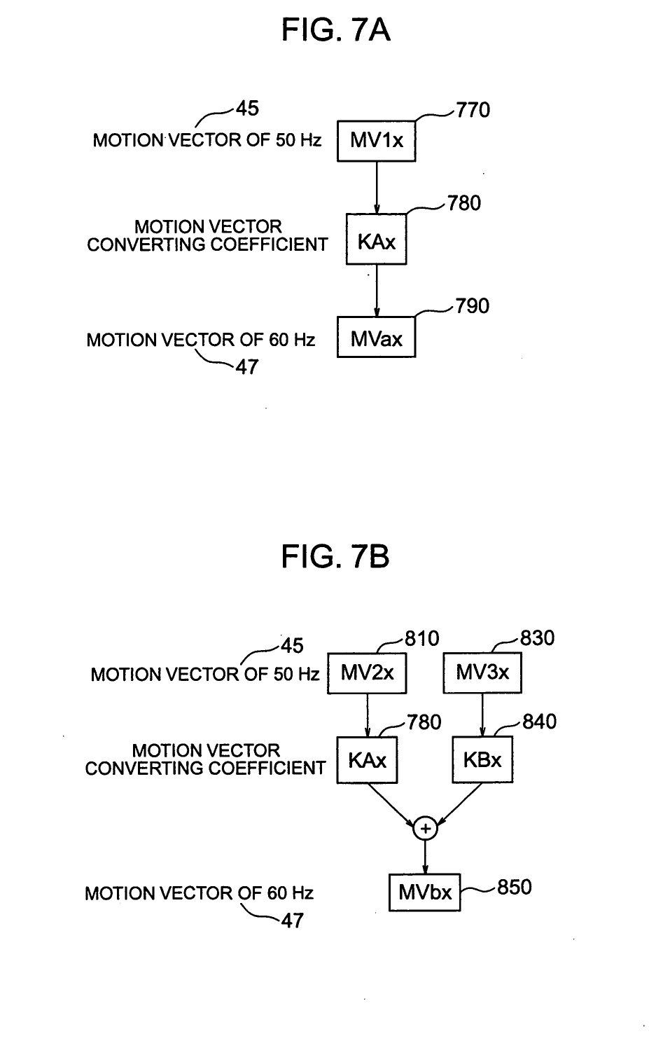

FIG. 7A and FIG. 7B are explanatory diagrams for showing rate converting sequences which are executed by the motion vector rate converting unit 31 when the motion vector 45 of 50 Hz is rate-converted into the motion vector 47 of 60 Hz.

In FIG. 7A and FIG. 7B, Fig. A shows a calculation sequence with employment of parameters in the first step (61) and the sixth step (71) represented in FIG. 5. That is to say, “MVax (790)” corresponding to the motion vector 47 of 60 Hz may be calculated by multiplying “MV1x (770)” corresponding to the motion vector 45 of 50 Hz by a motion vector converting coefficient “KAx (780)” corresponding to the first coefficient. FIG. 7B shows a calculation sequence with employment of parameters in the second step (63), the third step (65), the fourth step (67), and the fifth step (69) represented in FIG. 5. That is to say, “MVbx (850)” corresponding to the motion vector 47 of 60 Hz may be calculated by adding a product made by “MV2x (810)” corresponding to the motion vector 45 of 50 Hz and the motion vector converting coefficient “KAx (780)” corresponding to the first coefficient to another product made by “MV3x (830)” corresponding to the motion vector 45 of 50 Hz and the motion vector converting coefficient “KBx (840)” corresponding to the second coefficient.

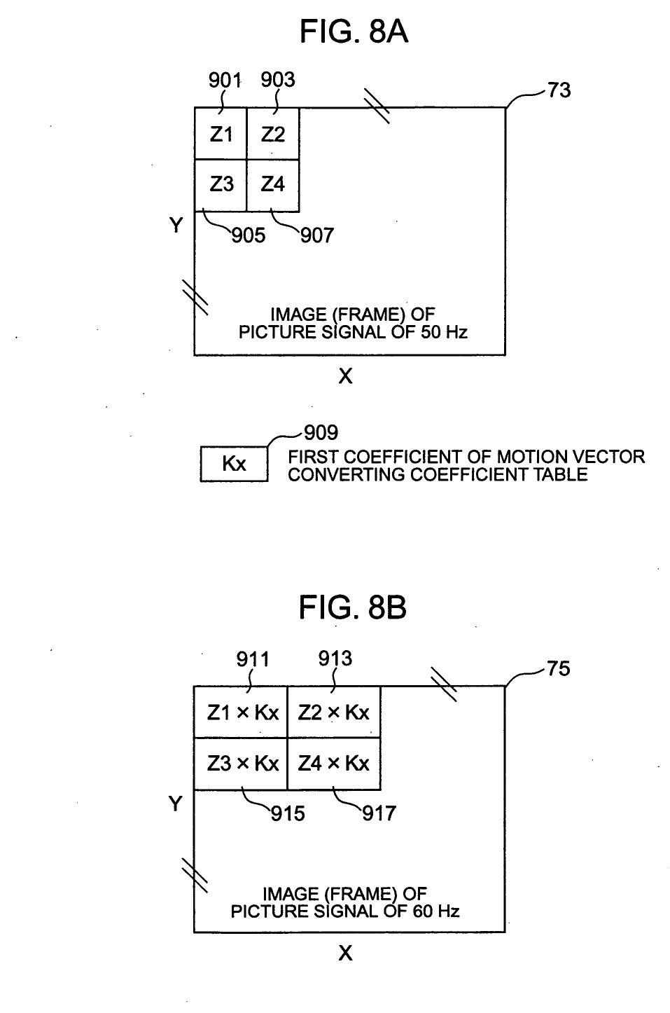

FIG. 8A and FIG. 8B are schematic diagrams for showing one example as to arranging relationship between the motion vector of 50 Hz and the motion vector of 60 Hz on the motion vector rate converting unit 31.

In FIG. 8A and FIG. 8B, there is shown one example as to arranging relationship between the motion vector (45) of 50 Hz and the motion vector (47) of 60 Hz in the motion vector rate converting unit 31 in such a case that the calculation sequence in the first step (61) shown in FIG. 5 is employed.

In FIG. 8A and FIG. 8B, FIG. 8A indicates one example as to arranging relationship of motion vectors of 50 Hz on the motion vector converting unit 31. In FIG. 8A, an image (frame) 73 of a picture signal of 50 Hz is constituted by X pixels along the horizontal direction and Y pixels along the vertical direction. In the frame 73, an attention is paid to 4 pieces of motion vectors Z1 (901), Z2 (903), Z3 (905), and Z4 (907) of 50 Hz, which correspond to 4 pieces of pixels located at an upper left corner. It is so assumed that the first coefficient has been set to “Kx (909)” in the motion vector converting coefficient table 300 shown in FIG. 5 of this case. It should also be understood that the image (frame) 73 of the picture signal of 50 Hz indicated in FIG. 8A corresponds to an image (frame) of an input picture signal inputted to the motion vector rate converting unit 31.

FIG. 8B indicates one example as to arranging relationship of motion vectors of 60 Hz on the motion vector converting unit 31. In FIG. 8B, an image (frame) 75 of a picture signal of 60 Hz is constituted by X pixels along the horizontal direction and Y pixels along the vertical direction in a similar manner to the above-described image (frame) 73 of the picture signal of 50 Hz. In other words, such motion vectors equal to a total pixel number indicated by “X·Y” are outputted from the motion vector rate converting unit 31 as the motion vectors of 60 Hz. In the 75, 4 pieces of the motion vectors of 60 Hz, which correspond to 4 pieces of pixels located at an upper left corner are denoted by “Z1·Kx (911)”, “Z2·Kx (913)”, “Z3·Kx (915)”, and “Z4·Kx (917).”

The above-described motion vectors of 60 Hz, namely “Z1·Kx (911)”, “Z2·Kx (913)”, “Z3·Kx (915)”, and “Z4·Kx (917)” are outputted from the motion vector rate converting unit 31.

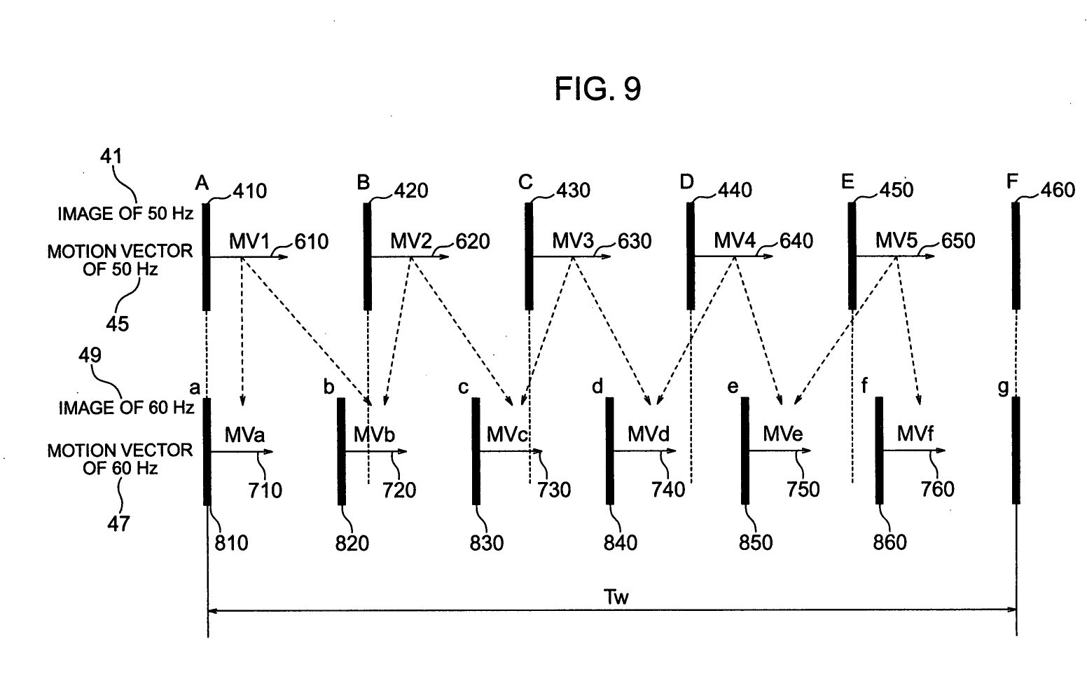

FIG. 9 is a schematic diagram for representing relationship between frames of a picture signal of 50 Hz and frames of a picture signal of 60 Hz on the time axis; and another relationship between motion vectors of 50 Hz and motion vectors of 60 Hz on the time axis.

In FIG. 9, a description is made of the below-mentioned exemplifications: That is, the image rate converting unit 21 performs such a rate converting operation for obtaining 6 frames of a picture signal of 60 Hz from 5 frames of a picture signal of 50 Hz within the above-described time period “Tw”; and also, the motion vector rate converting unit 31 performs such a rate converting operation for obtaining 6 frames of motion vectors of 60 Hz from 5 frames of motion vectors of 50 Hz within the above-described time period “Tw.”

As previously explained also in FIG. 4, a motion vector of 50 Hz is produced as a vector by referring to two sets of preceding/succeeding frames within the picture signal of 50 Hz, which are continued to each other in view of the temporal aspect so as to acquire the above-described vector corresponding to motion of pixels whose plane coordinates are equal to each other within a predetermined area. For instance, the motion vector MV1 (610) of 50 Hz is produced by referring to the frame A (410) of 50 Hz and the frame B (420) of 50 Hz, whereas the motion vector MV2 (620) of 50 Hz is produced by referring to the frame B (420) of 50 Hz and the frame C (430) of 50 Hz.

Also, the motion vector MV3 (630) of 50 Hz is produced by referring to the frame C (430) of 50 Hz and the frame D (440) of 50 Hz, whereas the motion vector MV4 (640) of 50 Hz is produced by referring to the frame D (440) of 50 Hz and the frame E (450) of 50 Hz. In addition, the motion vector MV5 (650) of 50 Hz is produced by referring to the frame E (450) of 50 Hz and the frame F (460) of 50 Hz.

Further in FIG. 9, as presented in FIG. 4, not only one picture signal of 50 Hz of two preceding/succeeding frames which are continued to each other (in view of temporal aspect) in the picture signal of 50 Hz is outputted from the image storage unit 19 in a so-called real time, in order that to which both the image rate converting unit 21 and the motion vector detecting unit 27 can refer to the two preceding/succeeding frames at the same time, but also one picture signal of 50 Hz which has been delayed by 1 frame is outputted. In FIG. 9, for the sake of easy explanations and easy illustrations, as shown in FIG. 4, the below-mentioned expression format is not employed: That is, as illustrated in FIG. 4, the same picture signal of 50 Hz is expressed in such a separate manner that one picture signal of 50 Hz has been delayed by 1 frame, and another picture signal of 50 Hz has not been delayed by 1 frame.

Since the corresponding relationship between the respective motion vectors 45 of 50 Hz and the respective motion vectors 47 of 60 Hz in order to acquire 6 frames of the motion vectors 47 of 60 Hz from 5 frames of the motion vectors 45 (namely, MV1 (610), MV2 (620), MV3 (630), MV4 (640), and MV5 (650)) of 50 Hz has already described, a detailed description thereof will be omitted in this example. The above-described 6 frames of motion vectors 47 of 60 Hz are the motion vectors MVa (710), MVb (720), MVc (730), MVd (740), MVe (750), and MVf (760).

A sequence for acquiring 6 frames of a picture signal of 60 Hz from 5 frames of a picture signal of 50 Hz, which is performed by the image rate converting unit 21, is given as follows:

That is, first of all, the frame A (410) of 50 Hz, which is synchronized with the starting period of the time period “Tw”, is directly outputted as a frame “a” (810) of 60 Hz. Next, if the frame B (420) of 50 Hz, the frame C (430) of 50 Hz, the frame D (440) of 50 Hz, and the frame E (450) of 50 Hz are compared with a frame “b” (820) of 60 Hz, a frame “c” (830) of 60 Hz, a frame “d” (840) of 60 Hz, a frame “e” (850) of 60 Hz, and a frame “f” (860) of 60 Hz, then any of the frame “b” (820) of 60 Hz through the frame “f” (860) of 60 Hz are not synchronized with the frame B (420) of 50 Hz to the frame E (450) of 50 Hz, which have the corresponding relationship therewith, on the time axis.

As a result, in order that the image rate converting unit 21 rate-converts the frame rate of the picture signal of 50 Hz into the frame rate of the picture signal of 60 Hz by producing frames of 60 Hz from frames of 50 Hz, the image rate converting unit 21 outputs such a frame as a frame of 60 Hz, while this frame is produced by synthesizing two sets of preceding/succeeding frames which are continued in view of the temporal aspect in accordance with a predetermined algorithm. For instance, the frame “b” (820) of 60 Hz corresponds to such a frame formed by synthesizing two sets of the frame A (410) of 50 Hz and the frame B (420) of 50 Hz with each other, which are approximated with respect to this frame “b” (820) of 60 Hz along forward/backward directions on the time axis. Also, the frame “c” (830) of 60 Hz corresponds to such a frame formed by synthesizing two sets of the frame C (430) of 50 Hz and the frame B (420) of 50 Hz with each other, which are approximated with respect to this frame “c” (830) of 60 Hz along forward/backward directions on the time axis.

Also, the frame “d” (840) of 60 Hz corresponds to such a frame formed by synthesizing two sets of the frame C (430) of 50 Hz and the frame D (440) of 50 Hz with each other, which are approximated with respect to this frame “d” (840) of 60 Hz along forward/backward directions on the time axis. Also, the frame “e” (850) of 60 Hz corresponds to such a frame formed by synthesizing two sets of the frame D (440) of 50 Hz and the frame E (450) of 50 Hz with each other, which are approximated with respect to this frame “e” (850) of 60 Hz along forward/backward directions on the time axis. In addition, the frame “f” (860) of 60 Hz corresponds to such a frame formed by synthesizing two sets of the frame E (450) of 50 Hz and the frame F (460) of 50 Hz with each other, which are approximated with respect to this frame “f” (860) of 60 Hz along forward/backward directions on the time axis.

As previously described, in the image correcting unit 23 shown in FIG. 2 and FIG. 3, the image correcting operation for the frames of 60 Hz outputted from the image rate converting unit 21 is carried out based upon the motion vectors outputted from the motion vector rate converting unit 31. In other words, the image correcting operation is carried out with respect to each of the frame “a” (810) of 60 Hz to the frame “f” (860) of 60 Hz, which are indicated in FIG. 9 and correspond to the below-mentioned motion vectors, by referring to each of the motion vector MVa (710) of 60 Hz to the motion vector MVf (760) of 60 Hz.

For example, the image correcting operation as to the frame “a2 (810) of 60 Hz is performed based upon the motion vector MVa (710) of 60 Hz; the image correcting operation as to the frame “b” (820) of 60 Hz is carried out based upon the motion vector MVb (720) of 60 Hz; and the image correcting operation as to the frame “c” (830) of 60 Hz is performed based upon the motion vector MVc (730) of 60 Hz. Also, the image correcting operation as to the frame “d” (840) of 60 Hz is performed based upon the motion vector MVd (740) of 60 Hz; the image correcting operation as to the frame “e” (850) of 60 Hz is carried out based upon the motion vector MVe (750) of 60 Hz; and the image correcting operation as to the frame “f” (860) of 60 Hz is carried out based upon the motion vector MVf (760) of 60 Hz, respectively.

FIG. 10 is an explanatory diagram for showing one example as to output timing of motion vectors 47 of 60 Hz from the motion vector rate converting unit 31, while these motion vectors 47 of 60 Hz are obtained by being rate-converted in the motion vector rate converting unit 31.

Since the relationship between the motion vectors of 50 Hz inputted to the motion vector rate converting unit 31 and the motion vectors of 60 Hz outputted from the motion vector rate converting unit 31 has already been explained with reference to FIG. 6, a description thereof will be omitted in this embodiment.

In the case that the motion vectors 47 of 60 Hz are produced in the motion vector rate converting unit 31, this production of the motion vectors 47 is synchronized with such an operation that the motion vector detecting unit 27 detects the motion vectors 45 of 50 Hz from the frames of the picture signal of 50 Hz outputted from the image storage unit 19, and then, these motion vectors 45 of 50 Hz are outputted from the motion vector detecting unit 27. The output timing of the motion vectors 47 of 60 Hz from the motion vector rate converting unit 31 will now be described by exemplifying the above-described time period (namely, such a time period designated for rate converting process operation when motion vector 45 of 50 Hz is rate-converted into motion vector 47 of 60 Hz).

For instance, the producing timing of the motion vector MVa (710) of 60 Hz is set in such a manner that this producing timing may be synchronized with such a timing when the motion vector MV1 (610) of 50 Hz is outputted from the motion vector detecting unit 27 via the motion vector storage unit 29 to the motion vector rate converting unit 31. Next, the producing timing of the motion vector MVb (720) of 60 Hz is set in such a manner that this producing timing may be synchronized with such a timing when the motion vector MV1 (610) of 50 Hz which has been temporarily stored in the motion vector temporary storage area 77 set in the motion vector storage unit 29 is outputted to the motion vector rate converting unit 31, and thereafter, the motion vector MV2 (620) of 50 Hz is outputted to the motion vector rate converting unit 31.

Next, the producing timing of the motion vector MVc (730) of 60 Hz is set in such a manner that this producing timing may be synchronized with such a timing when the motion vector MV2 (620) of 50 Hz which has been temporarily stored in the motion vector temporary storage area 77 is outputted to the motion vector rate converting unit 31, and thereafter, the motion vector MV3 (630) of 50 Hz is outputted to the motion vector rate converting unit 31. Next, the producing timing of the motion vector MVd (740) of 60 Hz is set in such a manner that this producing timing may be synchronized with such a timing when the motion vector MV3 (630) of 50 Hz which has been temporarily stored in the motion vector temporary storage area 77 is outputted to the motion vector rate converting unit 31, and thereafter, the motion vector MV4 (640) of 50 Hz is outputted to the motion vector rate converting unit 31.

Next, the producing timing of the motion vector MVe (750) of 60 Hz is set in such a manner that this producing timing may be synchronized with such a timing when the motion vector MV4 (640) of 50 Hz which has been temporarily stored in the motion vector temporary storage area 77 is outputted to the motion vector rate converting unit 31, and thereafter, the motion vector MV6 (650) of 50 Hz is outputted to the motion vector rate converting unit 31. Moreover, the producing timing of the motion vector MVf (760) of 60 Hz is set in such a manner that this producing timing may be synchronized with such a timing when the motion vector MV5 (650) of 50 Hz is outputted from the motion vector detecting unit 27 via the motion vector storage unit 29 to the motion vector rate converting unit 31.

As apparent from FIG. 10, except that the rate converting operation is performed from the motion vector MV5 (650) equal to the motion vector 45 of 50 Hz into the motion vector MVe (750) equal to the motion vector 47 of 60 Hz and the rate converting operation is performed from the motion vector 45 of 50 Hz into the motion vector MVf (760) equal to the motion vector 47 of 60 Hz, in the rate converting operation from the motion vector 45 of 50 Hz to the motion vector 47 of 60 Hz, a maximum time length required for executing a rate converting process of one motion vector is “Tw/5.” The above-described one motion vector rate converting process implies that one motion vector of 50 Hz is rate-converted into one motion vector of 60 Hz. However, in such a case that the rate converting operation is performed from the motion vectors MV4 (640) and MV5 (650) equal to the motion vector 45 of 50 Hz into the motion vector MVe (750) equal to the motion vector 47 of 60; and the rate converting operation is performed from the motion vector MV5 (650) equal to the motion vector 45 of 50 Hz into the motion vector MVf (760) equal to the motion vector 47 of 60 Hz, the rate converting operations into the two motion vectors MVe (750) and MVf (760) of 60 Hz are carried out at the same time within the last time period Tw/5.

As apparent from the above-described contents, in the case that the motion vector 47 of 60 Hz is produced from the motion vector 45 of 50 Hz, in the sequence for producing the motion vectors MVb (720) to MVe (750) corresponding to the motion vector 47 of 60 Hz, the motion vector rate converting unit 31 must refer to the newly inputted motion vector 45 of 50 Hz, and further, must refer to a motion vector of 50 Hz which was inputted in the rate converting process operation for one preceding motion vector in view of the temporal aspect. As a result, when the motion vector 45 of 50 Hz is outputted from the motion vector detecting unit 27, this inputted motion vector 45 of 50 Hz is outputted not only via the motion vector storage unit 29 to the motion vector rate converting unit 31, but also, as previously explained, is temporarily stored in the motion vector temporary storage area 77 set in the motion vector storage unit 29. Then, for instance, in such a case that the motion vector MVb (720) of 60 Hz is produced, when one preceding motion vector MVa (710) equal to the motion vector 47 of 60 Hz was produced, at which the motion vector MV1 (610) (equal to motion vector 45 of 50 Hz) was temporarily stored in the motion vector temporary storage area 77, this motion vector MV1 (610) is read out from the motion vector temporary storage area 77 by the motion vector rate converting unit 31. When the motion vectors MVc (730) to MVe (750) of 60 Hz are produced, process operations similar to the above-described process operation are carried out.

FIG. 11 is an explanatory diagram for showing another example as to output timing of motion vectors 47 of 60 Hz from the motion vector rate converting unit 31, while these motion vectors 47 of 60 Hz are obtained by being rate-converted in the motion vector rate converting unit 31.

In FIG. 10, within the above-described time period (namely, time period designated for rate converting process operation when motion vector 45 of 50 Hz is rate-converted into motion vector 47 of 60 Hz) “Tw”, only in such a time period “Tw/5” corresponding to the last time period, namely only when the motion vectors MVe (750) and MVf (760) of 60 Hz are produced, the motion vector rate converting unit 31 has referred to the motion vector MV5 (650) two times, which corresponds to the same motion vector 45 of 50 Hz. However, in the case that such a circuit system is manufactured by, for example, an LSI (Large-Scaled Integration), by which a motion vector of 50 Hz is detected from frames of picture signals of 50 Hz stored in the image storage unit 19, and then, the detected motion vector of 50 Hz is outputted to the motion vector rate converting unit 31, if a circuit arrangement for repeating a reading operation of the same data amount every predetermined time period is made, then the circuit design thereof can be readily made, and further, a higher efficiency can be achieved in view of circuit operations.

Under such a circumstance, as a consequence, in the output timing example of FIG. 11, as to the motion vector MVf (760) equal to the motion vector 47 of 60 Hz, it is so assumed that a copy of one preceding motion vector MVe (750) (corresponding to motion vector 47 of 60 Hz) thereof is employed. Since such a method is employed, a total time when the motion vector rate converting unit 31 refers to the motion vector MV5 (650) corresponding to the motion vector 45 of 50 Hz is reduced from 2 times to 1 time. Accordingly, the periodic characteristic of the reading operation for the motion vector 45 of 50 Hz in the above-described circuit system manufactured as the LSI structure can be held.

In the method shown in FIG. 11, the producing operation of the motion vector MVf (760) equal to the motion vector 47 of 60 Hz based upon the motion vector MV5 (650) equal to the motion vector 45 of 50 Hz by the motion vector rate converting unit 31 has been omitted, namely, the rate converting operation of the motion vector has been omitted. As a consequence, strictly speaking, there is a difference between the result obtained by employing the method shown in FIG. 11 and the result obtained by employing such a converting process method as shown in FIG. 10.

However, generally speaking, in a normal natural moving picture, it is known such a fact that among frames which are located adjacent to each other in view of a temporal aspect, correlative relationship among these pictures becomes strong. As a consequence, the following prediction may be made: That is, among the frames adjacent to each other in view of the temporal aspect, correlative relationship among motion vectors may be similarly strong. As a consequence, even if a copy of a partial motion vector of 50 Hz is employed as a plurality of motion vectors of 60 Hz in a predetermined reading time period for the above-described motion vector 45 of 50 Hz, it is possible to suppress an adverse influence to a minimum value. This adverse influence is caused by that images of picture signals of 60 Hz are corrected by employing these motion vectors 47 of 60 Hz (which have been obtained by frame rate converting operation) in the image correcting unit 23.

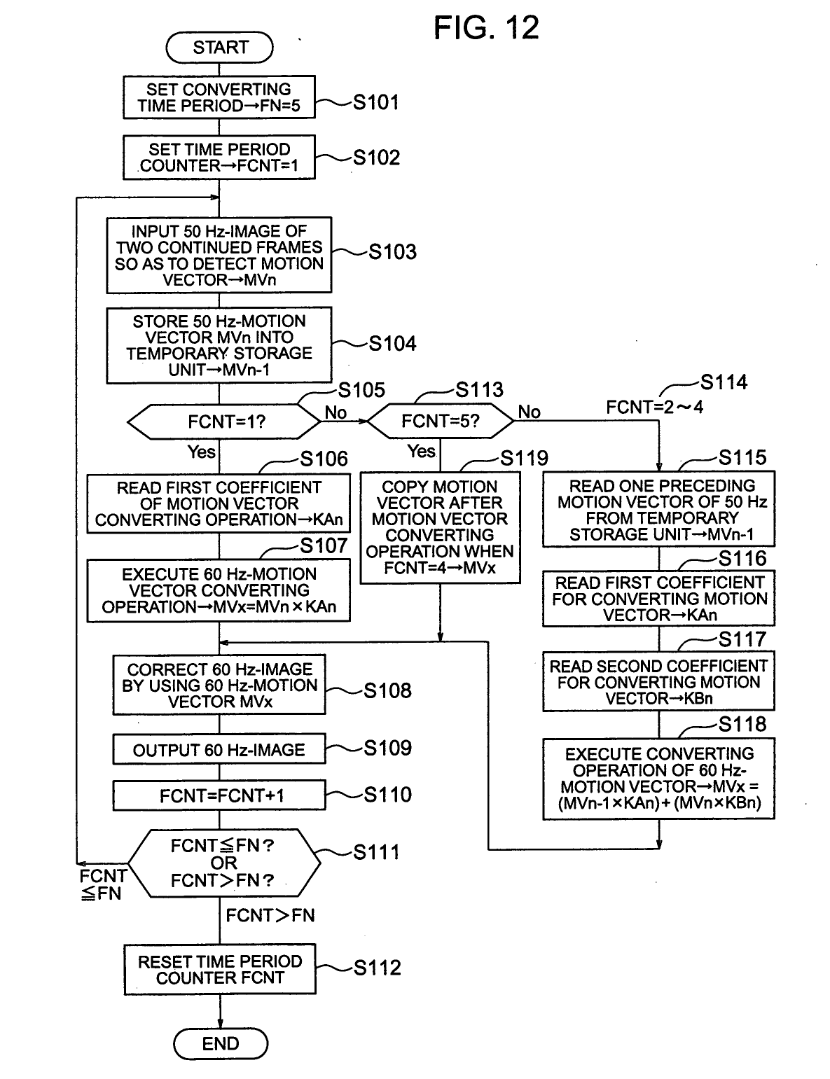

FIG. 12 is a flow chart for describing process operations performed in the respective structural units for constructing the image converting apparatus 200 when the image converting apparatus 200 shown in FIG. 2 performs image converting process operations.

In FIG. 12, first of all, based upon relationship between a frame rate of a picture signal which is inputted to the image converting apparatus 200 and a frame rate of a picture signal which is outputted from the image converting apparatus 200, both a frame rate and a converting time period “FN” of a rate of a motion vector are set. As one example, the rate converting time period “FN” from a picture signal of 50 Hz to a picture signal of 60 Hz is set to “5” (step S101). Next, a count value of a time period counter FCNT for recognizing a position on a time axis within the set converting time period is set to “1” (step S102). Next, the motion vector detecting unit 27 inputs thereinto two frames of the picture signal of 50 Hz from the image storage unit 19 so as to detect a motion vector “MVn” of 50 Hz (step S103), while these two frames of the picture signal are continued to each other in view of the temporal aspect.

Then, the motion vector detecting unit 27 executes a process operation and another process operation in a parallel manner (step S104). In the first-mentioned process operation, the motion vector detecting unit 27 immediately outputs the detected motion vector MVn of 50 Hz via the motion vector storage unit 29 to the motion vector rate converting unit 31. In the last-mentioned process operation, the motion vector detecting unit 27 stores the detected motion vector MVn of 50 Hz into the motion vector temporary storage area 77 in order that this detected motion vector MVn is delayed by 1 frame and the 1-frame delayed motion vector MVn is outputted to the motion vector rate converting unit 31. Next, the motion vector rate converting unit 31 checks whether or not the count value of the time period counter FCNT is “1” (step S105).

As a result of this checking operation, if FCNT=1, then the motion vector rate converting unit 31 reads out a first coefficient “KAn” from the motion vector converting coefficient table 300 shown in FIG. 5 (step S106), while the first coefficient “KAn” is required for rate-converting the motion vector 45 of 50 Hz into the motion vector 47 of 60 Hz. Then, the motion vector rate converting unit 31 performs such a calculating process operation (MVx=MVn×KAn) for performing a rate conversion with respect to the motion vector MVn of 50 Hz detected by the motion vector detecting unit 27 in the step S103 by employing this read first coefficient KAn so as to acquire a motion vector MVx of 60 Hz (step S107).

When the above-described motion vector MVx is outputted from the motion vector rate converting unit 31, the image correcting unit 23 performs an image correcting process operation in accordance with a predetermined algorithm with respect to a picture signal of 60 Hz outputted from the image rate converting unit 21 by employing the above-described motion vector MVx of 60 Hz (step S108). Then, the image correcting unit 23 outputs the above-described picture signal of 60 Hz to which the above-described image correcting process operation has been performed to the image output unit 25 (step S109). Next, the count value of the time period counter FCNT is incremented by (+1) (step S110), and a check is made whether or not the count value of the time period counter FCNT is smaller than, or equal to the converting time period FN set in the step S101, otherwise, another check is made whether or not the count value of the time period counter FCNT is larger than the converting time period FN set in the step S101 (step S111). As a result of this checking operation, when it is so judged that FCNT <FN, the process operation is returned to the process operation defined in the step S103. When it is so judged that FCNT>FN, the time period counter FCNT is set (step S112), so that a series of the process operations executed by the image converting apparatus 200 is accomplished.

In this case, since the count value of the time period counter FCNT before being incremented by (+1) in the step S110 is equal to “1”, the count value of the time period counter FCNT in the step S111 is “2.” As a result, the process operation is advanced to the step S103 without resetting the count value of the time period counter FCNT.

In the step S103, the motion vector detecting unit 27 detects the motion vector MVn of 50 Hz from two frames of the picture signal of 50 Hz, which are continued to each other in view of the temporal aspect; in the step S104, a process operation for immediately outputting the detected motion vector MVn of 50 Hz to the motion vector rate converting unit 31 is carried out, and another process operation for delaying the detected motion vector MVn by 1 frame is performed so as to output the delayed motion vector MVn to the motion vector rate converting unit 31; and thereafter, when the motion vector rate converting unit 31 judges that FCNT is not equal to “1” (“NO” in step S105), the motion vector rate converting unit 31 subsequently checks whether or not the count value of the time period counter FCNT is equal to “5” (step S113).

As a result of the above-described checking operation, if FCNT is not equal to “5” (NO in step S113), then the counter value of the time period counter FCNT must be equal to any one of “2” to “4.” Accordingly, the motion vector rate converting unit 31 reads out a motion vector “MVn−1” of 50 Hz which has been stored in 1 preceding rate converting time period from the motion vector temporary storage area 77 of the motion vector storage unit 29 (step S115), and also reads out the above-described first coefficient “KAn” from the motion vector converting table 300 (step S117).

Next, the motion vector rate converting unit 31 reads out the second coefficient “KBn” from the motion vector converting coefficient table 300 (step S118), while the second coefficient “KBn” is required so as to rate-convert the motion vector 45 of 50 Hz to the motion vector 47 of 60 Hz. Then, the motion vector rate converting unit 31 calculates a motion vector “MVx” of 60 Hz by employing the motion vector MVn of 50 Hz read in the step S103, the motion vector MVn−1 of 50 Hz acquired in the 1 preceding rate converting time period and read in the step S115, the first coefficient KAn read in the step S117, and the second coefficient KBn read in the step S118. In other words, the motion vector rate converting unit 31 calculates MVx=(MVn−1×KAn)+(MVn×KBn) (step S118). When the calculation defined in the step S118 is accomplished, the process operation is advanced to the process operation shown in the step S108.

In this case, since the count value of the time period counter FCNT before being incremented by (+1) in the step S110 is equal to any one of “2” to “4”, the count value of the time period counter FCNT in the step S111 is equal to any one of “3” to “5.” As a consequence, the process operation is advanced to the step S103, while the count value of the time period counter FCNT is not reset.

After the process operation shown in the step S103, the process operation indicated in the step S104, and the process operation represented in the step S105 have been carried out, when it is so judged that FCNT is equal to “5” (“YES” in step S113), the motion vector rate converting unit 31 copies the motion vector “MVx” corresponding to the motion vector of 60 Hz acquired in 1 preceding rate converting time period (namely, FCNT=4). Then, the copied motion vector MVx of 60 Hz is assumed as such a motion vector of 60 Hz under FCNT=5 (step S119). When the process operation shown in this step S119 is accomplished, the process operation is advanced to the above-described process operation shown in the step S108.

In this case, since the count value of the time period counter FCNT before being incremented by (+1) in the step S110 is equal to “5”, the count value of the time period counter FCNT in the step S111 is equal to “6.” As a consequence, the count value “6” of the time period counter FCNT is reset (step S112), and a series of the process operations is accomplished.

FIG. 13 is an explanatory diagram for indicating one example as to a thinning process for thinning motion vectors of 50 Hz which should be stored in the motion vector temporary storage area 77 set to the motion vector storage unit 29.

The thinning process operation for thinning the motion vectors of 50 Hz shown in FIG. 13 is provided in order to reduce the storage capacity of the motion vector temporary storage area 77, while a data amount of motion vectors of 50 Hz which should be stored in the motion vector temporary storage area 77 is thinned in accordance with a predetermined sequence. For instance, when the motion vector MVa (710) of 60 Hz is produced by rate-converting the motion vector MV1 (610) of 50 Hz, such a motion vector “SMV1 (123)” of 50 Hz obtained by performing a motion vector thinning process operation 121 with respect to the above-described motion vector MV1 (610) is stored in the motion vector temporary storage area 77.

Then, when a new motion vector “MVb (720)” of 60 Hz is produced in 1 succeeding rate converting time period from the above-described process operation, a motion vector restoring process 125 is carried out with respect to the above-described motion vector SMV1 (123) of 50 Hz, so that the above-described motion vector MV1 (610) is restored. The above-explained new motion vector MVb (720) of 60 Hz is produced in the motion vector rate converting unit 31 based upon this restored motion vector MV1 (610), and another motion vector MV2 (620) of 50 Hz which is newly read in the above-described 1 succeeding rate converting time period.

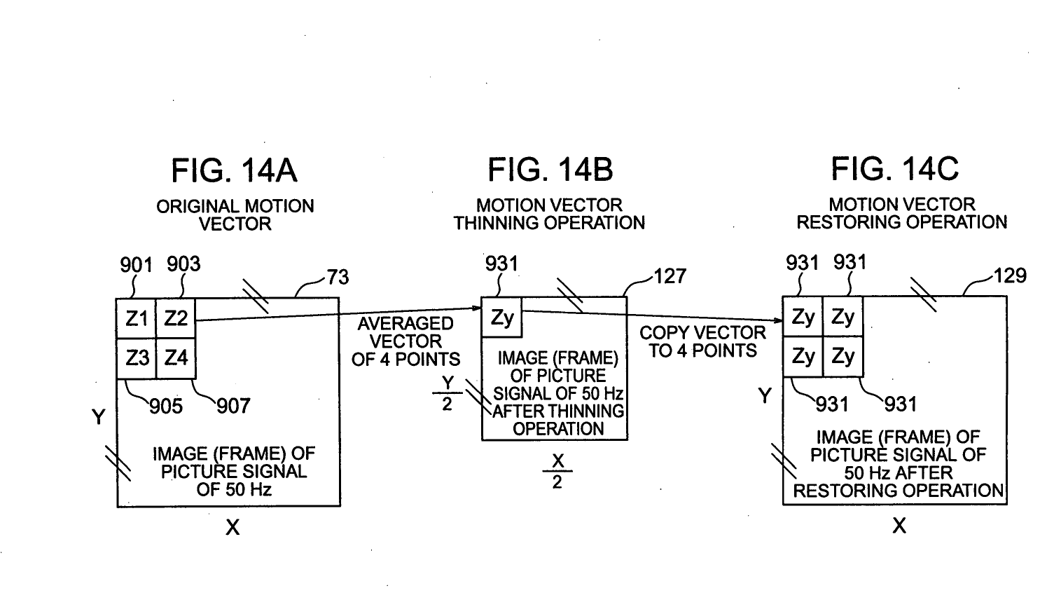

FIG. 14A to FIG. 14C are explanatory diagrams for describing operations executed in the thinning process for the motion vector MV1 of 50 Hz shown in FIG. 13, and also in the restoring process for the thinning-processed motion vector MV1 of 50 Hz.

FIG. 14A and FIG. 14B schematically indicate one example as to process operations performed in such a case that since the data amount of the moving vector MVn of 50 Hz is thinned in the motion vector thinning process operation 121 shown in FIG. 13 in such a manner that pixel numbers of this motion vector MVn are thinned by ½ along a lateral direction and a longitudinal direction, the original pixel numbers of the motion vector MVn of 50 Hz are thinned by ¼ in total.

In an image (frame) 73 of such a picture signal having a plurality of pixels (namely, pixel number along lateral direction is “X” and pixel number along longitudinal direction is “Y”, a total pixel number is “X·Y”), an attention should be paid to 4 pieces of motion vectors “Z1 (901)”, “Z2′ (903)”, “Z3 (905)”, and “Z4 (907)”, which correspond to 4 pieces of pixels located at an upper left corner of this image 73. In the motion vector thinning process operation 121, both a process operation for calculating “Zy (931)” and another process operation for storing the calculated “Zy (931)” are carried out. That is, in the first-mentioned process operation, a calculation is made of the above-described Zy (931) corresponding to an averaged value (averaged vector value) with respect to 4 pieces of these motion vectors Z1 (901), Z2 (903), Z3 (905), and Z4 (907). In the last-mentioned process operation, the calculated averaged value of Zy (931) is stored as a typical vector in, for example, the above-described motion vector temporary storage area 77 of the motion vector storage unit 29. In the motion vector thinning process operation 121, the above-described two process operations are carried out with respect to all of the pixels which constitute the image (frame) 73 of the picture signal of 50 Hz.

As a result, as represented in FIG. 14B, such an image (frame) 127 of a picture signal of 50 Hz is produced which contains a motion vector Zy (931) of 50 Hz whose data amount has been thinned by ¼. This image (frame) 127 of the picture signal of 50 Hz corresponds to such an image (frame) which has a pixel number of Y/2 along the longitudinal direction and a pixel number of X/2 along the lateral direction, respectively.

FIG. 14B and FIG. 14C schematically show one example as to process operations executed when the respective motion vectors Z1 (901) to Z4 (907) of 50 Hz before the thinning process operation by the motion vector thinning process 121 is performed are restored from the motion vector Zy (931) of 50 Hz which has been thinned in the motion vector restoring process 125 shown in FIG. 13. In other words, in the motion vector restoring process operation 125, one typical vector Zy (931) is copied with respect to each of the 4 same pixels as 4 pixels related to the motion vectors Z1 (901) to Z4 (907) before being thinned, so that such a data amount of the motion vector of 50 Hz, which is equal to the data amount of the motion vector before being thinned is restored in such an image (frame) of a picture signal (50 Hz) indicated by a sign 129 in FIG. 14C.

In the example shown in FIG. 14A to FIG. 14C, the below-mentioned thinning process operation was exemplified in such a case that a total thinning amount of a motion vector of 50 Hz is reduced by ¼ of a total data amount of the original motion vector of 50 Hz. However, since this thinning process operation merely constitutes one example as to the thinning process operations for thinning the data amounts of the motion vectors, thinning amounts of motion vectors related to respective pixels along the lateral direction and also related to respective pixels along the longitudinal direction within an image (frame) of a picture signal of 50 Hz may be alternatively set to an arbitrary data amount. In such a case that a thinning amount of a motion vector is set to a large amounts it is conceivable that precision in a motion vector value after a restoring process operation has been carried out is lowered when the restoring process operation is carried out for this motion vector. However, the thinning amount of the motion vector may be set to any arbitrary amount in response to any important aspect selected from precision of a motion vector value and the storage capacity of the motion vector temporary storage area 77.

In the above-described image converting apparatus 200 according to one embodiment of the present invention, such a case that the picture signal of 50 Hz is rate-converted into the picture signal of 60 Hz has been exemplified. However, the image converting apparatus 200 according to one embodiment of the present invention is not limited only to such an application range that the picture signal of 50 Hz is rate-converted into the picture signal of 60 Hz, but also, may be apparently applied to another case that a picture signal having a frame rate other than 50 Hz is rate-converted into a picture signal having a frame rate other than 60 Hz. In other words, while a plurality of standard specifications related to frame rates of picture signals are present, the above-described image converting apparatus 200 may be applied to any combinations made by that picture signals having any of these frame rates are employed as input picture signals and output picture signals.

As other examples as to combinations between frame rates of input picture signals and frame rates of output picture signals, the below-mentioned combinations may be conceived: That is, an input picture signal having a frame rate of 24 Hz may be combined with an output picture signal having a frame rate of 60 Hz; an input picture signal having a frame rate of 30 Hz may be combined with an output picture signal having a frame rate of 60 Hz; an input picture signal having a frame rate of 50 Hz may be combined with an output picture signal having a frame rate of 100 Hz; and an input picture signal having a frame rate of 60 Hz may be combined with an output picture signal having a frame rate of 120 Hz, and the like.

While the preferable embodiments of the present invention have been described, these embodiments have been merely exemplified, so that the technical scope of the present invention is not limited only to those embodiments. Apparently, the present invention may be embodied in various sorts of other embodiment modes.

1. An image converting apparatus comprising:
a frame rate converting unit for rate-converting a picture signal having a first frame rate which is inputted thereinto into a picture signal having a second frame rate to be outputted;
a motion vector detecting unit for detecting a motion vector from the picture signal having the first frame rate;
a motion vector rate converting unit for performing a predetermined calculating process operation with respect to the motion vector detected by said motion vector detecting unit so as to rate-convert said motion vector into such a motion vector having the same frame rate as the second frame rate of the picture signal; and
a picture signal correcting unit for correcting the picture signal having the second frame rate outputted from said frame rate converting unit by utilizing the motion vector whose rate has been converted by said motion vector rate converting unit.

2. An image converting apparatus as claimed in claim 1, wherein:
said motion vector detecting unit detects such a vector which passes through pixels whose positions are equal to each other between two sets of preceding/succeeding frames which are continued to each other in the picture signal having the first frame rate as a motion vector having said first frame rate.

3. An image converting apparatus as claimed in claim 2, wherein:
said motion vector detecting operation by said motion vector detecting unit is carried out with respect to all of pixels which constitute each of said frames.

4. An image converting apparatus as claimed in claim 2, wherein:
one of said two preceding/succeeding frames which are continued to each other in the picture signal having the first frame rate corresponds to a frame delayed by 1 frame, and the other frame thereof corresponds to a frame which is not delayed by 1 frame; and said motion vector is detected by referring to said both frames at the same time.

5. An image converting apparatus as claimed in claim 1, wherein:
said rate converting operation of the motion vector by said motion vector rate converting unit contains a sequence for performing a predetermined calculating process operation by employing said two preceding/succeeding motion vectors which are continued to each other and are detected from the picture signal having the first frame rate by said motion vector detecting unit.

6. An image converting apparatus as claimed in claim 1, wherein:
said rate converting operation of the motion vector by said motion vector rate converting unit contains a sequence for performing a predetermined calculating process operation by employing a copy of a motion vector detected from the picture signal having the first frame rate by said motion vector detecting unit, which has been produced in one preceding rate converting operation within the rate converting operation at the present time.

7. An image converting apparatus as claimed in claim 5, wherein:
said predetermined calculating process operation corresponds to such a calculating process operation with employment of a first coefficient, or both the first coefficient and a second coefficient, which are required so as to rate-convert the motion vector detected from the picture signal having the first frame rate by said motion vector detecting unit.

8. An image converting apparatus as claimed in claim 7, wherein:
a ratio of said first coefficient to said second coefficient is variably changed in response to a time period of rate-converting operation for rate-converting the motion vector of the picture signal having the first frame rate into the motion vector of the picture signal having the second frame rate, while said time period is determined based upon the picture signal having the first frame rate and the picture signal having the second frame rate.

9. An image converting apparatus as claimed in claim 1, wherein:
the motion vector detected by said motion vector detecting unit is saved under such a condition that an information amount of said motion vector has been thinned in accordance with a predetermined sequence; and when said motion vector is rate-converted by said motion vector rate converting unit, the thinned information amount of said motion vector is restored to the original information amount thereof in accordance with the predetermined sequence.

10. A digital TV (television) broadcasting receiver comprising:
a picture signal input/output unit for inputting/outputting a picture signal;
an image displaying unit;
a picture signal processing unit for performing a predetermined signal process operation with respect to the supplied picture signal and for outputting the signal-processed picture signal to said image display unit; and
a recording/reproducing unit for recording thereon the picture signal entered via said picture signal input/output unit, and for reproducing the recorded picture signal to output the reproduced picture signal to any one of said picture signal input/output unit and said picture signal processing unit; and wherein:
said picture signal processing unit includes:
a frame rate converting unit for rate-converting a picture signal having a first frame rate which is inputted thereinto into a picture signal having a second frame rate to be outputted;
a motion vector detecting unit for detecting a motion vector from the picture signal having the first frame rate;
a motion vector rate converting unit for performing a predetermined calculating process operation with respect to the motion vector detected by said motion vector detecting unit so as to rate-convert said motion vector into such a motion vector having the same frame rate as the second frame rate of the picture signal; and
a picture signal correcting unit for correcting the picture signal having the second frame rate outputted from said frame rate converting unit by utilizing the motion vector whose rate has been converted by said motion vector rate converting unit.

11. An image converting method comprising:
a first step for rate-converting a picture signal having a first frame rate which is inputted thereinto into a picture signal having a second frame rate to be outputted;
a second step for detecting a motion vector from the picture signal having the first frame rate;
a third step for performing a predetermined calculating process operation with respect to the motion vector detected in said second step so as to rate-convert said motion vector into such a motion vector having the same frame rate as the second frame rate of the picture signal; and
a fourth step for correcting the picture signal having the second frame rate outputted in said first step unit by utilizing the motion vector whose rate has been converted in said third step.
